(19) United States
(12) Patent Application Publication
(10) Pub. No.: US 2019/0241807 A1
(43) Pub. Date: Aug. 8, 2019

(54) LIQUID CRYSTAL COMPOSITION AND LIQUID CRYSTAL DISPLAY

(71) Applicants: SHARP KABUSHIKI KAISHA, Osaka (JP); ORGANO SCIENCE CO., LTD., Omaezaki-shi (JP); CHIRACOL CO., LTD., Saitama-shi (JP)

(72) Inventors: Masanobu MIZUSAKI, Tenri-shi (JP); Tsuyoshi OKAZAKI, Tenri-shi (JP); Yuko TERAOKA, Tenri-shi (JP); Kazuo OKAMOTO, Omaezaki-shi (JP); Toshihiro SHIBATA, Omaezaki-shi (JP)

(73) Assignees: SHARP KABUSHIKI KAISHA, Osaka (JP); ORGANO SCIENCE CO., LTD., Omaezaki-shi (JP); CHIRACOL CO., LTD., Saitama-shi (JP)

(21) Appl. No.: 16/270,260

(22) Filed: Feb. 7, 2019

(30) Foreign Application Priority Data
Feb. 8, 2018 (JP) 2018-021203

(51) Int. Cl. C09K 19/30; C09K 19/54; C09K 19/12; C09K 19/16

(52) U.S. Cl. CPC C09K 19/3003; C09K 19/542; C09K 19/12; C09K 2019/0448; C09K 2019/3004; C09K 2019/161; C09K 2019/548; C09K 19/16

(57) ABSTRACT

Liquid crystal displays having quick response and high light resistance are provided. A liquid crystal composition includes:
(A) a cyclohexane compound of formula [I]:

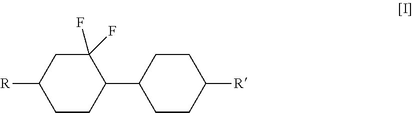

wherein R and R′ are each independently a C₁-C₆ linear alkyl group;
(B) a compound that is different from cyclohexane compound (A) and is a liquid crystal; and
(C) at least one polymerizable compound selected from the group consisting of
   a polymerizable compound of formula [II]:

P¹-Sp¹-E-Sp²-P² [II]
wherein, e.g., P¹ and P² are each an acryloyloxy group, Sp¹ and Sp² are each an alkyleneoxy group or a direct bond, and E is an arylene group, and
   a polymerizable compound of formula [III]:

A-(L-W)ᵢ-(M-Z)ⱼ—(N)ₖ—B [III]
wherein, e.g., A and B are each P-Q-, P is a polymerizable group, Q is a spacer group or a single bond, i quantity of L and k quantity of N are each phenylene, j quantity of M are each phenylene, i quantity of W and j quantity of Z are each —O—, i and k are 0 or 1 with the proviso that i+k>0, j is 0, 1, 2 or 3, and n is 1, 2, 3 or 4; and optionally includes:
(D) a photopolymerization initiator.

### FIELD OF THE INVENTION

The present invention relates to a liquid crystal composition containing a specific cyclohexane compound and a specific polymerizable compound, and to a liquid crystal display using the liquid crystal composition.

### BACKGROUND ART

Optical anisotropy (Δn) (hereinafter sometimes referred to as “Δn”) and dielectric anisotropy (Δε) (hereinafter sometimes referred to as “Δε”) are features of liquid crystal compounds. Utilizing these properties, there have been manufactured many liquid crystal display devices. Such liquid crystal display devices have been used in watches or clocks, calculators, measurement instruments, automobile instrument panels, word processors, electronic organizers, cellular phones, printers, computers, TV sets and the like. Liquid crystal compounds used in liquid crystal display devices have inherent liquid crystal phases, which are broadly divided into nematic phase, smectic phase and cholesteric phase. Of these, nematic phase is most widely used.

Liquid crystal compounds used in any of these display devices should be stable to environmental factors such as moisture, air, heat and light. They are also required to exhibit a liquid crystal phase at a broad range of temperatures as possible including room temperature, to have appropriate dielectric anisotropy (Δε) and refractive index anisotropy (Δn), to be quick in response, and to be able to be driven at a low voltage. In order to satisfy these properties, liquid crystals having a low viscosity and a low threshold voltage are necessary. At present, there is no single compound that satisfies all of the above conditions, and the needs are met by mixing several to several tens of liquid crystal compounds. In addition, a further improvement in response speed is requested to keep up with the recent high-definition TV broadcasting and 3D displaying.

There have been made many proposals on nematic liquid crystal compositions superior in responsiveness using cyclohexane compounds. For example, Patent Literature 1 presents a nematic liquid crystal composition with high response speed that can be pre-tilted at a large pretilt angle, generate markedly less stripe domains, be chemically stable, be driven at a low voltage and be adaptable to high-level multiplex driving. Patent Literature 2 presents a novel cyclohexane compound which gives a nematic liquid crystal composition that has a desired birefringence index, can be driven in a wide range of temperatures, be superior in responsiveness and offer a good contrast. This cyclohexane compound, when used in the above composition, realizes liquid crystal display devices such as TN-LCDs, STN-LCDs and TFT-LCDs having improved electrooptic properties. This nematic liquid crystal composition is an antiferroelectric liquid crystal composition that is improved in response speed from antiferroelectric state to ferroelectric state. Further, Patent Literature 3 presents a material having a cyclohexane ring for liquid crystal display cells and, when mixed into generally used liquid crystal compositions, does not give rise to an increase in viscosity and allows the threshold voltage to be effectively reduced. Unfortunately, the materials presented so far are incapable of satisfying the response speed.

The polymer sustained alignment (PSA) technique introduces a pretilt into a liquid crystal material by using a polymerizable compound. In a general summary of this technique, a liquid crystal composition containing a liquid crystal compound and a polymerizable compound is filled in the space between a TFT substrate having an alignment film and a counter substrate to make a liquid crystal cell, and the polymerizable compound in the liquid crystal composition is then polymerized by irradiation under the application of a predetermined voltage to form an alignment controlling layer on the alignment film, thereby causing the molecules of the liquid crystal compound to tilt in the absence of voltage application. This technique is said to outperform the PVA system in response time. In another approach to align a liquid crystal composition, a photosensitive polyimide (PI) is previously applied to a substrate to form an alignment film, then UV light is applied at a tilt angle so as to align polyimide molecules, and thereafter a liquid crystal composition is introduced and aligned. This technique is also featured in high response speed. Further, a technique (hereinafter referred to “PI-less technique”) has been developed, in which a polymerizable compound is incorporated into a liquid crystal material to make a liquid crystal composition, the liquid crystal composition is poured into a liquid crystal cell having no alignment films composed of polyimide or the like, the polymerizable compound is polymerized by irradiation of UV light to form an alignment controlling layer on the substrate, and the molecules of the liquid crystal compound is aligned. Also to all of these techniques, improvement in response speed is requested.

Alkenyl compounds have conventionally been used as viscosity depressants in liquid crystal compositions, in particular, negative liquid crystal compositions. Unfortunately, however, there has been a problem of occurrence of burn-in after a long-term use of liquid crystal displays (LCDs) using such a liquid crystal composition. In particular, burn-in is more likely to occur in PSA (polymer sustained alignment) liquid crystal displays due to the voltage holding ratio (VHR) being lowered. It is believed that the reason therefor is due to the fact that alkenyl compounds, which are poorly resistant to UV light, are suffered from such deterioration as cleavage by irradiation with light, which is performed in the PSA technique for forming an alignment controlling layer.

### CITATION LIST

### Patent Literature

Patent Literature 1: JPH06-56717A

Patent Literature 2: JPH07-126205A

Patent Literature 3: JP2012-180284A

### SUMMARY OF THE INVENTION

### Technical Problem

Objects of the present invention are to provide a liquid crystal composition which does not cause a decrease in VHR even when subjected to UV irradiation for the formation of a polymer layer, and to provide a liquid crystal display (LCD) with high response speed and high light resistance using the liquid crystal composition.

### Solution to Problem

The present invention embraces the following:

[1] A liquid crystal composition comprising:

(A) a cyclohexane compound represented by the following formula [I]:

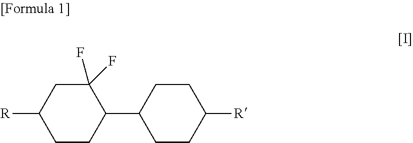

wherein R and R′ are each independently a C₁-C₆ linear alkyl group;

(B) a compound that is different from cyclohexane compound (A) and is a liquid crystal; and

(C) at least one polymerizable compound selected from the group consisting of:

a polymerizable compound represented by the following formula [II]:

[Formula 2]

P¹-Sp¹-E-Sp²-P² [II]

wherein P¹ and P² are the same as or different from one another and are each an acryloyloxy group, a methacryloyloxy group, an acryloylamino group, a methacryloylamino group, a vinyl group or a vinyloxy group,

Sp¹ and Sp² are the same as or different from one another and are each a C₁-C₆ linear, branched or cyclic alkylene group, a C₁-C₆ linear, branched or cyclic alkyleneoxy group, or a direct bond, and

E is a C₁₀-C₃₂ arylene group optionally linked by a single bond, —COCH═CH— or —CH═CHCO—, and

a polymerizable compound represented by the following formula [III]:

[Formula 3]

A-(L-W)ᵢ-(M-Z)ⱼ—(N)ₖ—B [III]

wherein A and B are the same as or different from one another and are each P-Q-, H, halogen, SF₅, NO₂, a carbon group or a hydrocarbon group, with the proviso that at least one of A and B is P-Q-,

P is a polymerizable group,

Q is a spacer group or a single bond,

i quantity of L and k quantity of N are the same as or different from one another and are each 1,3-phenylene, 1,4-phenylene, naphthalene-1,3-diyl, naphthalene-1,6-diyl, naphthalene-2,5-diyl, naphthalene-2,7-diyl (wherein one or more CH groups of these groups may be substituted with a nitrogen atom), cyclohexane-1,3-diyl (wherein one or more CH₂ groups thereof not adjacent to one another may be replaced by an oxygen atom and/or a sulfur atom), 1,3-cyclohexenylene, piperidine-2,4-diyl, piperidine-2,6-diyl, decahydronaphthalene-2,7-diyl, 1,2,3,4-tetrahydronaphthalene-2,7-diyl or indane-2,4-diyl, with the proviso that all of the above groups may be unsubstituted or mono- or polysubstituted with T, and when i=k=1, either group L or group N may have one of meanings defined for M,

j quantity of M are the same as or different from one another and are each 1,3-phenylene, 1,4-phenylene, naphthalene-1,4-diyl, naphthalene-2,6-diyl (wherein one or more CH groups of these groups may be substituted with a nitrogen atom), cyclohexane-1,4-diyl (wherein one or more CH₂ groups thereof not adjacent to one another may be replaced by an oxygen atom and/or a sulfur atom), 1,4-cyclohexenylene, bicyclo[1.1.1]pentane-1,3-diyl, bicyclo[2.2.2]octane-1,4-diyl, spiro[3.3]heptane-2,6-diyl, piperidine-2,5-diyl, decahydronaphthalene-2,6-diyl, 1,2,3,4-tetrahydronaphthalene-2,6-diyl, indane-2,5-diyl, thiophene-2,5-diyl, fluorene-2,7-diyl or octahydro-4,7-methanoindane-2,5-diyl, with the proviso that all of the above groups may be unsubstituted or mono- or polysubstituted with T and may have one of meanings defined for L,

T is P-Q-, H, OH, halogen, SF₅, NO₂, a carbon group or a hydrocarbon group,

i quantity of W and j quantity of Z are the same as or different from one another and are each —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)—, —CF₂CH₂—, —CH₂CF₂—, —(CF₂)ₙ—, —CH═CH—, —CF═CF—, —C≡—, —CH═CH—COO—, —OCO—CH═CH—, —CUV or a single bond,

U and V are each independently H or a C₁-C₁₂ alkyl group,

i and k are each independently 0 or 1, with the proviso that i+k>0,

j is 0, 1, 2 or 3, and

n is 1, 2, 3 or 4,

with the proviso that when polymerizable compound (C) includes a polymerizable compound of formula [III], R and R′ in formula [I] for cyclohexane compound (A) are not n-propyl groups at the same time.

[2] The liquid crystal composition described in [1], further comprising:

(D) a photopolymerization initiator.

[3] The liquid crystal composition described in [1] or [2], wherein polymerizable compound (C) is a polymerizable compound of formula [II].

[4] The liquid crystal composition described in [3], wherein P¹ and P² in formula [II] are acryloyloxy groups.

[5] The liquid crystal composition described in any one of [1] to [4], wherein polymerizable compound (C) is selected from the group consisting of:

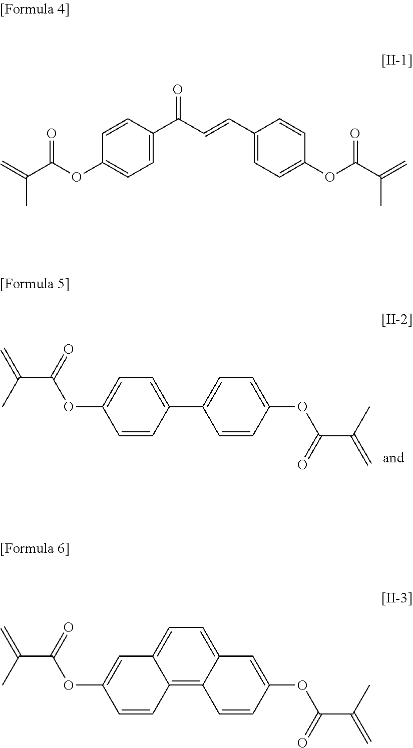

[6] The liquid crystal composition described in any one of [1] to [5], comprising 5 to 90% by weight of cyclohexane compound (A).

[7] The liquid crystal composition described in any one of [1] to [6], comprising 5 to 90% by weight of liquid crystal compound (B).

[8] The liquid crystal composition described in any one of [1] to [7], comprising less than 5% by weight of polymerizable compound (C).

[9] The liquid crystal composition described in any one of [2] to [8], comprising less than 8% by weight of photopolymerization initiator (D).

[10] A liquid crystal display comprising:

a pair of substrates,

a liquid crystal layer disposed between the pair of substrates and comprising a liquid crystal composition, and

an alignment controlling layer that is disposed in contact with the liquid crystal layer and controls alignment of the liquid crystal composition,

wherein the liquid crystal composition comprises the liquid crystal composition described in any one of [1] to [9], and

wherein the alignment controlling layer comprises a polymer resulting from polymerization of the polymerizable compound and a photopolymerization initiator that are contained in the liquid crystal composition for forming the liquid crystal layer.

[11] The liquid crystal display described in [10], further comprising:

an alignment film in at least one space between the alignment controlling layer and the substrate.

[12] The liquid crystal display described in [10] or [11], wherein the alignment film comprises a polymer compound comprising polyimide, polyamide or polysiloxane.

[13] The liquid crystal display described in [12], wherein the alignment film comprises polyimide.

[14] The liquid crystal display described in any one of [10] to [13], of a display mode of TN mode, IPS mode, FFS mode or (M)VA mode.

### Advantageous Effects of Invention

The cyclohexane compound of formula [I] is resistant to light and effectively reduces the viscosity of liquid crystal composition. Introduction of the cyclohexane compound into a liquid crystal composition as viscosity depressant in place of any poorly light resistant alkenyl compound permits manufacture of a liquid crystal display having quick response and light resistance. Further, although a light-labile liquid crystal composition cannot be used for the PSA and PI-less techniques involving UV irradiation for the formation of a polymer layer, the liquid crystal composition of the present invention containing the light-stable cyclohexane compound of formula [I] can be effectively used in these techniques.

### BRIEF DESCRIPTION OF THE DRAWINGS

FIG. 1 is a schematic view of a liquid crystal cell according to an embodiment of the present invention.

FIG. 2 is a schematic view of a liquid crystal cell according to an embodiment of the present invention.

FIG. 3 is a schematic view of a liquid crystal cell according to another embodiment of the present invention.

FIG. 4 is a schematic view of a liquid crystal cell according to another embodiment of the present invention.

### DESCRIPTION OF EMBODIMENTS

The technical terms in the present specification are used in the following manner. The term “liquid crystal composition” means a mixture containing one, or two or more kinds of liquid crystal compounds having a liquid crystal phase such as nematic phase or smectic phase; or a mixture containing one, or two or more kinds of liquid crystal compounds having a liquid crystal phase, and one, or two or more kinds of compounds having no liquid crystal phases. The term “liquid crystal display device” means a liquid crystal display panel or a liquid crystal display module.

[Cyclohexane Compound (A) of Formula [I]]

A liquid crystal composition of the present invention contains a cyclohexane compound (A) represented by the following formula [I]:

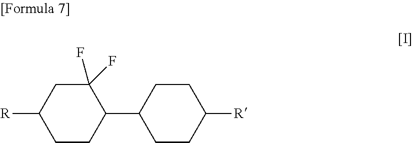

wherein R and R′ are each independently a C₁-C₆ linear alkyl group.

Specific examples of the C₁-C₆ linear alkyl groups include methyl, ethyl, n-propyl, n-butyl, n-pentyl and n-hexyl, and preferably ethyl, n-propyl and n-butyl.

Some specific examples of cyclohexane compound (A) of formula [I] are listed as follows:

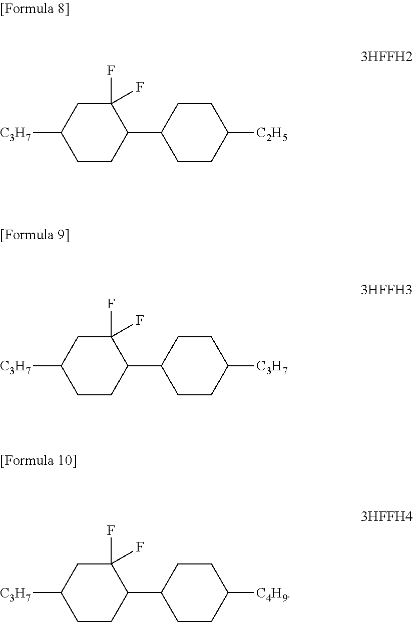

Cyclohexane compound (A) of formula [I] may be present as a mixture of stereoisomers.

Cyclohexane compound (A) of formula [I] may be produced by any method without limitation. For example, the compounds may be produced in accordance with the production of 3HFFH3 by the scheme below. The details are also disclosed in Japanese Patent Application No. 2016-177274.

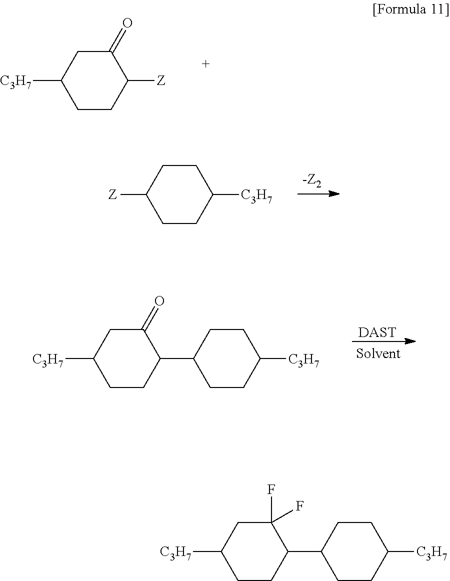

In the above scheme, Z denotes a halogen atom.

[Compound (B) that is Different from Cyclohexane Compound (A) and is a Liquid Crystal]

The liquid crystal composition of the present invention contains a compound (B) that is different from cyclohexane compound (A) and is a liquid crystal. In the following description, compound (B) that is different from cyclohexane compound (A) and is a liquid crystal is sometimes referred to as “mother liquid crystal”.

The type of the liquid crystal compound (B) is not particularly limited as long as the compound is different from cyclohexane compound (A) and is a liquid crystal. For example, the liquid crystal compound (B) may be at least one selected from liquid crystal compounds represented by the formulae (2) and (3) below:

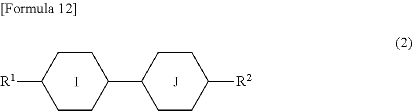

In formula (2), R¹ is a C₁-C₆ linear alkyl group, ring I is a cyclohexane ring or a benzene ring, ring J is a cyclohexane ring or is a benzene ring optionally having halogen atoms on two adjacent carbon atoms, and R² is a C₁-C₆ linear alkyl group or a C₁-C₆ linear alkoxy group.

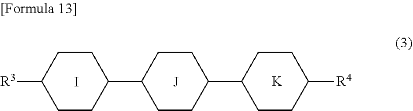

In formula (3), R³ is a C₁-C₆ linear alkyl group, ring I is a cyclohexane ring or a benzene ring, ring J is a cyclohexane ring or is a benzene ring optionally having halogen atoms on two adjacent carbon atoms, ring K is a benzene ring optionally having halogen atoms on two adjacent carbon atoms, and R⁴ is a C₁-C₆ linear alkyl group or a C₁-C₆ linear alkoxy group.

The term “halogen atom” means fluorine, chlorine, bromine or iodine. Fluorine is preferable.

Some specific examples of the liquid crystal compound are listed as follows:

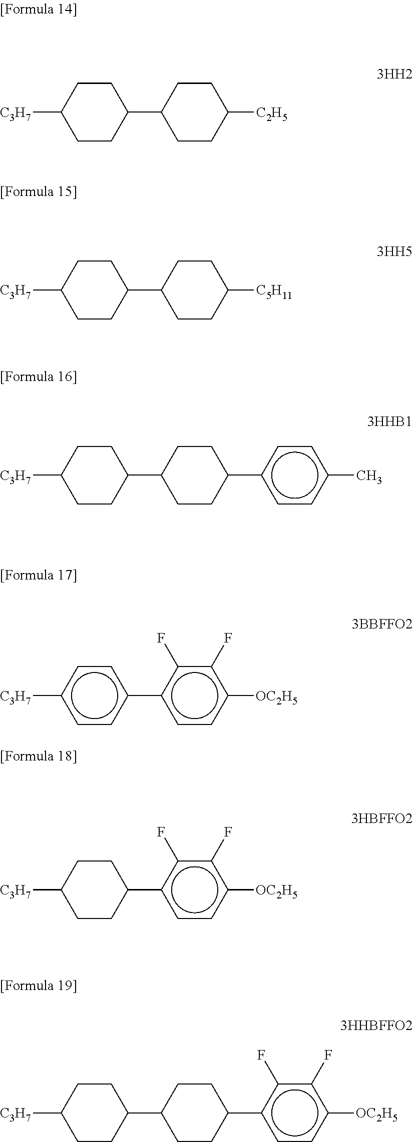

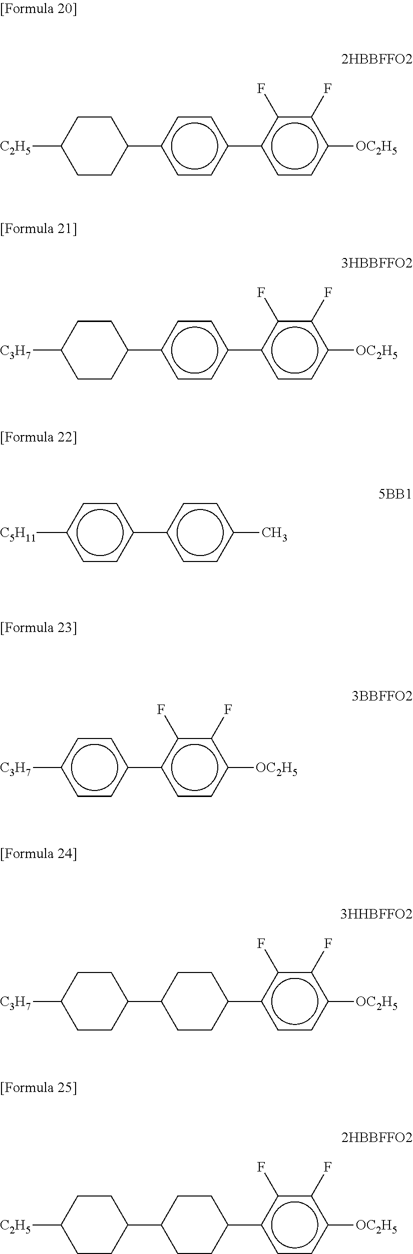

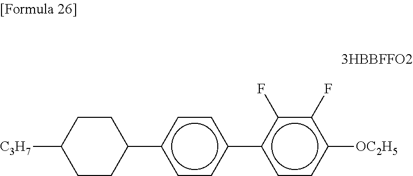

Liquid crystal compounds other than those shown above will be illustrated in EXAMPLES later. The liquid crystal compounds are blended in appropriate proportions to constitute the mother liquid crystal of the liquid crystal composition of the present invention. In the mother liquid crystal, the lower limit of the weight ratio of liquid crystal compound (B) free from halogen to liquid crystal compound (B) containing halogen is preferably 1:20, and more preferably 1:15; and the upper limit thereof is preferably 2:1, and more preferably 1:1. Preferably, the total amount of liquid crystal compound (B) ranges 5 to 90% by weight of the liquid crystal composition.

[Polymerizable Compound (C)]

The liquid crystal composition of the present invention contains at least one polymerizable compound selected from the group consisting of a polymerizable compound represented by formula [II] below and a polymerizable compound represented by formula [III] below.

The polymerizable compound (C) of formula [II] are as follows:

[Formula 27]

P¹-Sp¹-E-Sp²-P² [II]

In the formula, P¹ and P² are the same as or different from one another and are each an acryloyloxy group, a methacryloyloxy group, an acryloylamino group, a methacryloylamino group, a vinyl group or a vinyloxy group,

Sp¹ and Sp² are the same as or different from one another and are each a C₁-C₆ linear, branched or cyclic alkylene group, a C₁-C₆ linear, branched or cyclic alkyleneoxy group, or a direct bond, and

E is a C₁₀-C₃₂ arylene group optionally linked by a single bond, —COCH═CH— or —CH═CHCO—.

Examples of the C₁-C₆ linear, branched or cyclic alkylene group include methylene, ethylene, 1,3-propylene, 1,2-propylene, 2-methyl-1,3-propylene, 2-methyl-1,2-propylene, 1,4-butylene, 1,3-butylene, 1,2-butylene, 1,2-cyclopentylene, 1,3-cyclopentylene and 1,4-cyclohexylene.

Examples of the C₁-C₆ linear, branched or cyclic alkyleneoxy group include oxymethylene, oxyethylene, oxypropylene, oxybutylene, oxypentylene, oxyhexylene, oxycyclopentylene and oxycyclohexylene.

Examples of the C₁₀-C₃₂ arylene group optionally linked by a single bond, —COCH═CH— or —CH═CHCO— include naphthalenediyl, phenanthrenediyl, anthracenediyl, and biphenylene optionally interrupted with a single bond, —COCH═CH— or —CH═CHCO—.

The chemical structures of some examples are shown below.

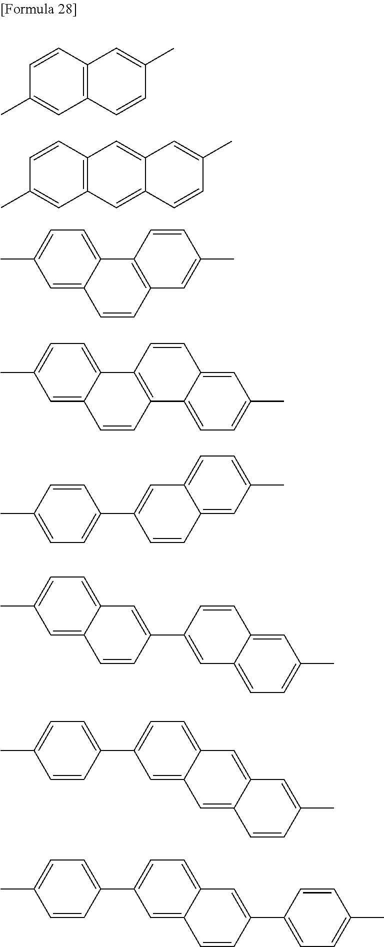

Polymerizable compound (C) of formula [III] is represented by the following formula (12):

[Formula 29]

A-(L-W)₁-(M-Z)ⱼ-(N)ₖ-B (12)

In formula (12), A and B are the same as or different from one another and are each P-Q-, H, halogen, SF₅, NO₂, a carbon group or a hydrocarbon group, with the proviso that at least one of A and B is P-Q-,

P is a polymerizable group,

Q is a spacer group or a single bond,

i quantity of L and k quantity of N are the same as or different from one another and are each 1,3-phenylene, 1,4-phenylene, naphthalene-1,3-diyl, naphthalene-1,6-diyl, naphthalene-2,5-diyl, naphthalene-2,7-diyl (wherein one or more CH groups of these groups may be substituted with a nitrogen atom), cyclohexane-1,3-diyl (wherein one or more CH₂ groups thereof not adjacent to one another may be replaced by an oxygen atom and/or a sulfur atom), 1,3-cyclohexenylene, piperidine-2,4-diyl, piperidine-2,6-diyl, decahydronaphthalene-2,7-diyl, 1,2,3,4-tetrahydronaphthalene-2,7-diyl or indane-2,4-diyl, with the proviso that all of the above groups may be unsubstituted or mono- or polysubstituted with T, and when i=k=1, either group L or group N may have one of meanings defined for M,

j quantity of M are the same as or different from one another and are each 1,3-phenylene, 1,4-phenylene, naphthalene-1,4-diyl, naphthalene-2,6-diyl (wherein one or more CH groups of these groups may be substituted with a nitrogen atom), cyclohexane-1,4-diyl (wherein one or more CH₂ groups thereof not adjacent to one another may be replaced by an oxygen atom and/or a sulfur atom), 1,4-cyclohexenylene, bicyclo[1.1.1]pentane-1,3-diyl, bicyclo[2.2.2]octane-1,4-diyl, spiro[3.3]heptane-2,6-diyl, piperidine-2,5-diyl, decahydronaphthalene-2,6-diyl, 1,2,3,4-tetrahydronaphthalene-2,6-diyl, indane-2,5-diyl, thiophene-2,5-diyl, fluorene-2,7-diyl or octahydro-4,7-methanoindane-2,5-diyl, with the proviso that all of the above groups may be unsubstituted or mono- or polysubstituted with T and may have one of meanings defined for L,

T is P-Q-, H, OH, halogen, SF₅, NO₂, a carbon group or a hydrocarbon group,

i quantity of W and j quantity of Z are the same as or different from one another and are each —O—, —S—, —CO—, —CO—O—, —OCO—, —O—CO—O—, —OCH₂—, —CH₂O—, —SCH₂—, —CF₂O—, —(CH₂)—, —CF₂CH₂—, —CH₂CF₂—, —(CF₂)ₙ—, —CH═CH—, —CF═CF—, —C≡—, —CH═CH—COO—, —OCO—CH═CH—, —CUV or a single bond,

U and V are each independently H or a C₁-C₁₂ alkyl group,

i and k are each independently 0 or 1, with the proviso that i+k>0,

j is 0, 1, 2 or 3, and

n is 1, 2, 3 or 4.

A particularly preferred polymerizable compound of formula (12) is such that:

L, M, N, W, Z, P, Q, i, j, k and n are as defined above,

T is P-Q-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted C₆-C₂₀ aryl, or C₁-C₂₅ linear or branched alkyl, alkoxy, alkylcarbonyl, alkoxycarbonyl, alkylcarbonyloxy or alkoxycarbonyloxy, with the proviso that one or more hydrogen atoms may be replaced by F, Cl or P-Q-,

Y¹ is halogen,

R^{x} is P-Q-, H, halogen, C₁-C₂₅ linear, branched or cyclic alkyl (in which one or more CH₂ groups thereof not adjacent to one another may be replaced by —O—, —S—, —CO—, —CO—O—, —O—CO— or —O—CO—O— in such a manner that atoms of oxygen and/or sulfur are not directly bonded to one another, or one or more hydrogen atoms thereof may be substituted with F, Cl or P-Q-), optionally substituted C₆-C₄₀ aryl or aryloxy, or optionally substituted C₂-C₄₀ heteroaryl or heteroaryloxy, and

A and B are each P-Q-, H, T as defined above or a C₁-C₂₅ linear or branched alkyl, with the proviso that one or more CH₂ groups thereof not adjacent to one another may be, independently of one another, replaced by —C(R^{x})═C(R^{x})—, —C≡C—, —N(R^{x})—, —O—, —S—, —CO—, —CO—O—, —O—CO— or —O—CO—O— in such a manner that atoms of oxygen and/or sulfur are not directly bonded to one another, or one or more hydrogen atoms thereof may be replaced by F, Cl, Br, I, CN or P-Q-, and with the proviso that at least one of groups A and B is P-Q-.

Preferably, A and B are groups P-Q- which are the same as or different from one another.

Preferably, A and B are groups P-Q- which are the same as or different from one another, with the proviso that at least one Q is a single bond.

Preferably, one of A and B is P-Q-, and the other is T defined as above or a C₁-C₂₅ linear or branched alkyl, with the proviso that one or more CH₂ groups thereof not adjacent to one another may be, independently of one another, replaced by —C(R^{x})═C(R^{x})—, —C≡C—, —N(R^{x})—, —O—, —S—, —CO—, —CO—O—, —O—CO— or —O—CO—O— in such a manner that atoms of oxygen and/or sulfur are not directly bonded to one another, and that one or more hydrogen atoms may be replaced by F, Cl, Br, I, CN or P-Q-.

Preferably, Q is a single bond.

Preferably, W and Z are each a single bond.

Preferably, M is selected from 1,3-phenylene, 1,4-phenylene, naphthalene-1,4-diyl, naphthalene-2,6-diyl (wherein one or more CH groups of these groups may be substituted with a nitrogen atom), cyclohexane-1,4-diyl (wherein one or more CH₂ groups thereof not adjacent to one another may be replaced by an oxygen atom and/or a sulfur atom), 1,4-cyclohexenylene, bicyclo[1.1.1]pentane-1,3-diyl, bicyclo[2.2.2]octane-1,4-diyl, spiro[3.3]heptane-2,6-diyl, piperidine-2,5-diyl, decahydronaphthalene-2,6-diyl, 1,2,3,4-tetrahydronaphthalene-2,6-diyl, indane-2,5-diyl, thiophene-2,5-diyl, fluorene-2,7-diyl and octahydro-4,7-methanoindane-2,5-diyl, with the proviso that all of the above groups may be unsubstituted or mono- or polysubstituted with T.

Preferably, M is selected from 1,3-phenylene, 1,4-phenylene, naphthalene-1,4-diyl and naphthalene-2,6-diyl (wherein one or more CH groups of these groups may be substituted with a nitrogen atom), with the proviso that all of the above groups may be unsubstituted or mono- or polysubstituted with T.

Preferably, L and N are selected from 1,3-phenylene, 1,4-phenylene, naphthalene-1,3-diyl, naphthalene-1,6-diyl, naphthalene-2,5-diyl and naphthalene-2,7-diyl (wherein one or more CH groups of these groups may be substituted with a nitrogen atom), with the proviso that all of the above groups may be unsubstituted or mono- or polysubstituted with T.

Where group L and/or group N is linked to the adjacent ring group L, M or N or to the corresponding bridging group W or Z at meta or para position, such group L and/or group N preferably has one or more substituents T that are P-Q-.

Preferably, i=k=1, and j=0, 1 or 2.

Preferably, i=j=0, and k=1.

The term “halogen” represents F, Cl, Br or I.

For example, polymerizable group P is a group that is suited for polymerization reactions such as free radical or ionic chain polymerization, polyaddition and polycondensation, or a group that is suited for polymer-analogous reactions such as addition or condensation onto polymer main chains. Particularly preferred are those having groups for chain polymerization, in particular, a C═C double bond or a C≡C triple bond, and groups suited for ring opening polymerization such as oxetane or epoxy groups.

Group P is preferably selected from CH₂═CW¹—COO—, CH₂═CW¹—CO—,

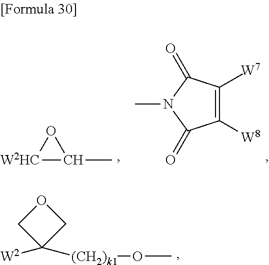

CH₂═CW²—(O)ₖ₃—, CW¹═CH—CO—(O)ₖ₃—, CW¹═CH—CO—NH—, CH₂═CW¹—CO—NH—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, (CH₂═CH—CH₂)₂N—CO—, HO—CW²W³—, HS—CW²W³—, HW²N—, HO—CW²W³—NH—, CH₂═CW¹—CO—NH—, CH₂═CH—(COO)ₖ₁-Phe-(O)ₖ₂—, CH₂═CH—(CO)ₖ₁-Phe-(O)ₖ₂—, Phe-CH═CH—, HOOC—, OCN— and W⁴W⁵W⁶Si— wherein W¹ is H, F, Cl, CN, CF₃, phenyl or C₁-C₅ alkyl, in particular, H, F, Cl or CH₃, W² and W³ are each independently H or C₁-C₅ alkyl, in particular, H, methyl, ethyl or n-propyl, W⁴, W⁵ and W⁶ are each independently Cl or C₁-C₅ oxyalkyl or oxycarbonylalkyl, W⁷ and W⁸ are each independently H, Cl or C₁-C₅ alkyl, Phe is 1,3- or 1,4-phenylene optionally substituted with one or more groups T defined as above, k₁, k₂ and k₃ are each independently 0 or 1, and k₃ is preferably 1.

Particularly preferred groups P are CH₂═CH—COO—, CH₂═C(CH₃)—COO—, CH₂═CH—, CH₂═CH—O—, (CH₂═CH)₂CH—OCO—, (CH₂═CH)₂CH—O—,

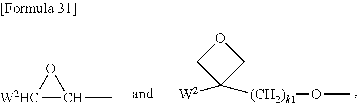

in particular, vinyloxy, acrylate, methacrylate, fluoroacrylate, chloroacrylate, oxetane and epoxide.

Spacer groups Q are known to those skilled in the art. For example, they are described in Pure Appl. Chem. Vol. 73 (No. 5), p. 888 (2001) and C. Tschierske, G. Pelzl, S. Diele, Angew. Chem. 2004, Vol. 116, pp. 6340-6368. Unless otherwise indicated, the spacer group is a flexible group that links a mesogenic group and one or more polymerizable groups in a reactive mesogen compound (hereinafter sometimes referred to “RM”).

The mesogenic groups are known to those skilled in the art and are documented. They are groups that essentially contribute to the generation of liquid crystal (LC) phases in low-molecular or high-molecular substances by the anisotropy of attractive and repulsive interactions. A liquid crystal compound containing a mesogenic group (a mesogen compound) does not necessarily have a liquid crystal phase in itself. A mesogen compound may exhibit a liquid crystal phase behavior only after being mixed and/or being polymerized with other compound. For example, typical mesogenic groups are rigid rod- or disk-shaped units. General terms and definitions used in connection with mesogen compounds or liquid crystal compounds are described in Pure Appl. Chem. Vol. 73 (No. 5), p. 888 (2001) and C. Tschierske, G. Pelzl, S. Diele, Angew. Chem. 2004, Vol. 116, pp. 6340-6368.

The reactive mesogen (RM) is a polymerizable compound containing a mesogenic group and one or more functional groups suited for polymerization (one or more polymerizable groups P).

The spacer group is preferably selected from Q′-X′ so that the group “P-Q-” corresponds to the formula “P-Q′-X′”.

Here, Q′ is C₁-C₂₀ alkylene, preferably C₁-C₁₂ alkylene, which may be mono- or polysubstituted with F, Cl, Br, I or CN and wherein one or more CH₂ groups thereof not adjacent to one another may be replaced by —O—, —S—, —NH—, —NR⁰—, —SiR⁰R⁰⁰—, —CO—, —COO—, —OCO—, —S—CO—, —CO—S—, —NR⁰—CO—O—, —O—CO—NR⁰—, —NR⁰—CO—NR⁰—, —CH═CH— or —C≡C— independently of one another so that atoms of oxygen and/or sulfur are not directly bonded to one another;

X′ is —O—, —S—, —CO—, —COO—, —OCO—, —O—COO—, —CO—NR⁰—, —NR⁰—CO—, —NR⁰—CO—NR⁰—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰—, —CY²═CY³—, —C≡C—, —CH═CH—COO—, —OCO—CH═CH— or a single bond;

R⁰ and R⁰⁰ are each independently H or C₁-C₁₂ alkyl; and

Y² and Y³ are each independently H, F, Cl or CN.

X′ is preferably —O—, —S—, —CO—, —COO—, —COO—, —O—COO—, —CO—NR⁰—, —NR⁰—CO—, —NR⁰—CO—NR⁰— or a single bond.

For example, Q′ is typically —(CH₂)ₚ₁—, —(CH₂CH₂O)_{q1}—CH₂CH₂—, —CH₂CH₂—S—CH₂CH₂—, —CH₂CH₂—NH—CH₂CH₂— or —(SiR⁰R⁰⁰—O)ₚ₁— wherein p1 is an integer of 1 to 12, q1 is an integer of 1 to 3, and R⁰ and R⁰⁰ are as defined above.

Particularly preferably, —X′-Q′- is —(CH₂)ₚ₁—, —O—(CH₂)ₚ₁—, —OCO—(CH₂)ₚ₁— or —OCOO—(CH₂)ₚ₁—.

Particularly preferably, Q′ is selected from, for example, ethylene, propylene, butylene, pentylene, hexylene, heptylene, octylene, nonylene, decylene, undecylene, dodecylene, octadecylene, ethyleneoxyethylene, methyleneoxybutylene, ethylenethioethylene, ethylene-N-methyliminoethylene, 1-methylalkylene, ethenylene, propenylene and butenylene, which are all linear.

The term “carbon group” means a monovalent or polyvalent organic group containing one or more carbon atoms, which contains no other atom (such as, for example, —C≡C—) or optionally further contains one or more atoms such as, for example, N, O, S, P, Si, Se, As, Te and Ge (such as, for example, carbonyl). The term “hydrocarbon group” means a carbon group which further contains one or more hydrogen atoms and which may optionally further contain one or more heteroatoms such as, for example, N, O, S, P, Si, Se, As, Te and Ge.

The carbon groups or hydrocarbon groups may be saturated groups or unsaturated groups. An unsaturated group is aryl, alkenyl or alkynyl, for example. The carbon groups or hydrocarbon groups having more than three carbon atoms may be linear, branched and/or cyclic, and may have a Spiro bond or a condensed ring.

Preferred carbon groups and hydrocarbon groups are optionally substituted C₁-C₄₀, preferably C₁-C₂₅, particularly preferably C₁-C₁₈ alkyl, alkenyl, alkynyl, alkoxy, alkylcarbonyl, alkoxycarbonyl, alkylcarbonyloxy and alkoxycarbonyloxy groups, optionally substituted C₆-C₄₀, preferably C₆-C₂₅ aryl and aryloxy groups, and optionally substituted C₆-C₄₀, preferably C₆-C₂₅ alkylaryl, arylalkyl, alkylaryloxy, arylalkyloxy, arylcarbonyl, aryloxycarbonyl, arylcarbonyloxy and aryloxycarbonyloxy groups.

More preferred carbon groups and hydrocarbon groups are C₁-C₄₀ alkyl, C₂-C₄₀ alkenyl, C₂-C₄₀ alkynyl, C₃-C₄₀ allyl, C₄-C₄₀ alkyldienyl, C₄-C₄₀ polyenyl, C₆-C₄₀ aryl, C₆-C₄₀ alkylaryl, C₆-C₄₀ arylalkyl, C₆-C₄₀ alkylaryloxy, C₆-C₄₀ arylalkyloxy, C₂-C₄₀ heteroaryl, C₄-C₄₀ cycloalkyl and C₄-C₄₀ cycloalkenyl groups. Particularly preferred groups are C₁-C₂₂ alkyl, C₂-C₂₂ alkenyl, C₂-C₂₂ alkynyl, C₃-C₂₂ allyl, C₄-C₂₂ alkyldienyl, C₆-C₁₂ aryl, C₆-C₂₀ arylalkyl and C₂-C₂₀ heteroaryl groups.

Still more preferable carbon groups and hydrocarbon groups are C₁-C₄₀, preferably C₁-C₂₅ linear, branched or cyclic alkyl groups, which are unsubstituted or mono- or polysubstituted with F, Cl, Br, I or CN and wherein one or more CH₂ groups thereof not adjacent to one another may be replaced by —C(R^{x})═C(R^{x})—, —C≡C—, —N(R^{x})—, —O—, —S—, —CO—, —CO—O—, —O—CO— or —O—CO—O— independently of one another so that atoms of oxygen and/or sulfur are not directly bonded to one another.

R^{x} is preferably H, halogen, C₁-C₂₅ linear, branched or cyclic alkyl chain (wherein one or more carbon atoms thereof not adjacent to one another may be replaced by —O—, —S—, —CO—, —CO—O—, —O—CO— or —O—CO—O— and one or more hydrogen atoms thereof may be replaced by fluorine), an optionally substituted C₆-C₄₀ aryl or aryloxy group, or an optionally substituted C₅-C₄₀ heteroaryl or heteroaryloxy group.

The terms “alkyl”, “aryl”, “heteroaryl”, etc. are understood to embrace polyvalent groups, for example, alkylene, arylene and heteroarylene.

The “aryl” is referred to aromatic carbon groups and groups derived therefrom. The “heteroaryl” is referred to “aryl” as defined above, which contains one or more heteroatoms.

Preferred alkyl groups are methyl, ethyl, n-propyl, isopropyl, n-butyl, isobutyl, s-butyl, t-butyl, 2-methylbutyl, n-pentyl, s-pentyl, cyclopentyl, n-hexyl, cyclohexyl, 2-ethylhexyl, n-heptyl, cycloheptyl, n-octyl, cyclooctyl, n-nonyl, n-decyl, n-undecyl, n-dodecyl, dodecanyl, trifluoromethyl, perfluoro-n-butyl, 2,2,2-trifluoroethyl, perfluorooctyl and perfluorohexyl.

Preferred alkenyl groups are ethenyl, propenyl, butenyl, pentenyl, cyclopentenyl, hexenyl, cyclohexenyl, heptenyl, cycloheptenyl, octenyl and cyclooctenyl.

Preferred alkynyl groups are ethynyl, propynyl, butynyl, pentynyl, hexynyl and octynyl.

Preferred alkoxy groups are methoxy, ethoxy, 2-methoxyethoxy, n-propoxy, i-propoxy, n-butoxy, i-butoxy, s-butoxy, t-butoxy, 2-methylbutoxy, n-pentoxy, n-hexoxy, n-heptyloxy, n-octyloxy, n-nonyloxy, n-decyloxy, n-undecyloxy and n-dodecyloxy.

The aryl and heteroaryl groups may be monocyclic or polycyclic. That is, they may have one ring (such as, for example, phenyl) or two or more rings, and the two or more rings may be condensed (such as, for example, naphthyl), may be linked through a covalent bond (such as, for example, biphenyl) or may be a combination of a condensed ring and linked rings. The heteroaryl groups contain one or more heteroatoms, preferably one or more heteroatoms selected from O, N, S and Se.

Particularly preferable are monocyclic, bicyclic or tricyclic aryl groups having 6 to 25 carbon atoms, and monocyclic, bicyclic or tricyclic heteroaryl groups having 2 to 25 carbon atoms, and these groups may contain a condensed ring and may be substituted. Further, 5-membered, 6-membered or 7-membered aryl and heteroaryl groups are preferable. In these groups, one or more CH groups may be replaced by a nitrogen atom, a sulfur atom or an oxygen atom so that atoms of oxygen and/or sulfur are not directly bonded to one another.

Preferred aryl groups are phenyl, biphenyl, terphenyl, [1,1′:3′,1″]terphenyl-2′-yl, naphthyl, anthracene, binaphthyl, phenanthrene, pyrene, dihydropyrene, chrysene, perylene, tetracene, pentacene, benzopyrene, fluorene, indene, indenofluorene and spirobifluorene.

Preferred heteroaryl groups are 5-membered rings such as pyrrole, pyrazole, imidazole, 1,2,3-triazole, 1,2,4-triazole, tetrazole, furan, thiophene, selenophene, oxazole, isoxazole, 1,2-thiazole, 1,3-thiazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole and 1,3,4-thiadiazole; 6-membered rings such as pyridine, pyridazine, pyrimidine, pyrazine, 1,3,5-triazine, 1,2,4-triazine, 1,2,3-triazine, 1,2,4,5-tetrazine, 1,2,3,4-tetrazine and 1,2,3,5-tetrazine; condensed rings such as indole, isoindole, indolizine, indazole, benzimidazole, benzotriazole, purine, naphthimidazole, phenanthroimidazole, pyridoimidazole, pyrazinoimidazole, quinoxalinoimidazole, benzoxazole, naphthoxazole, anthroxazole, phenanthroxazole, isoxazole, benzothiazole, benzofuran, isobenzofuran, dibenzofuran, quinoline, isoquinoline, pteridine, benzo-5,6-quinoline, benzo-6,7-quinoline, benzo-7,8-quinoline, benzoisoquinoline, acridine, phenothiazine, phenoxazine, benzopyridazine, benzopyrimidine, quinoxaline, phenazine, naphthylidine, azacarbazole, benzocarboline, phenanthridine, phenanthroline, thieno[2,3b]thiophene, thieno[3,2b]thiophene, dithienothiophene, isobenzothiophene, dibenzothiophene and benzothiadiazothiophene; and combinations of these groups. The heteroaryl groups may be substituted with alkyl, alkoxy, thioalkyl, fluorine, fluoroalkyl, additional aryl or additional heteroaryl group.

The aryl groups, the heteroaryl groups, the carbon groups and the hydrocarbon groups may have one or more substituents. The substituents are preferably selected from the group containing silyl, sulfo, sulfonyl, formyl, amine, imine, nitrile, mercapto, nitro, halogen, C₁-C₁₂ alkyl, C₆-C₁₂ aryl, C₁-C₁₂ alkoxy, hydroxyl and combinations thereof.

For example, preferred substituents are dissolution promoting groups such as alkyl and alkoxy, electron attracting groups such as fluorine, nitro and nitrile, and groups which increase the glass transition temperature (Tg) of polymers, in particular, bulky groups such as t-butyl and optionally substituted aryl groups.

For example, more preferred substituents are F, Cl, Br, I, —CN, —NO₂, —NCO, —NCS, —OCN, —SCN, —C(═O)N(R^{x})₂, —C(═O)Y¹, —C(═O)R^{x} and —N(R^{x})₂ in which R^{x} is as defined above, and Y¹ is halogen, optionally substituted silyl, optionally substituted C₆-C₄₀, preferably C₆-C₂₀ aryl, or C₁-C₂₅ linear or branched alkyl, alkoxy, alkylcarbonyl, alkoxycarbonyl, alkylcarbonyloxy or alkoxycarbonyloxy, with the proviso that one or more hydrogen atoms may be replaced by F or Cl.

The substituted silyl or aryl may be preferably substituted with halogen, —CN, R⁰, —OR⁰, —CO—R⁰, —CO—O—R⁰, —O—CO—R⁰ or —O—CO—O—R⁰. R⁰ is as defined above.

For example, still more preferred substituents are F, Cl, CN, NO₂, CH₃, C₂H₅, OCH₃, OC₂H₅, COCH₃, COC₂H₅, COOCH₃, COOC₂H₅, CF₃, OCF₃, OCHF₂, OC₂F₅ and phenyl.

The polymerizable compound of formula (12) preferably contains one or more branched groups R^{a} and/or R^{b} having two or more polymerizable groups P, and/or one or more polyfunctional polymerizable groups. Appropriate groups of this type and polymerizable compounds containing such groups are described in, for example, U.S. Pat. No. 7,060,200 and U.S. Patent Application Publication No. 2006/0172090 A1. Polyfunctional polymerizable groups selected from the following formulae are particularly preferable.

[Formula 32]

—X-alkyl-CHP¹—CH₂—CH₂P² I*a

—X-alkyl-C(CH₂P¹)(CH₂P²)—CH₂P³ I*b

—X-alkyl-CHP¹CHP²—CH₂P³ I*c

—X-alkyl-C(CH₂P¹)(CH₂P²)—CₐₐH₂ₐₐ₊₁ I*d

—X-alkyl-CHP¹—CH₂P² I*e

—X-alkyl-CHP¹P² I*f

—X-alkyl-CP¹P²—Cₐₐ₁H₂ₐₐ₊₁ I*g

—X-alkyl-C(CH₂P¹)(CH₂P²)—CH₂OCH₂—C(CH₂P³)(CH₂P⁴)CH₂P⁵ I*h

—X-alkyl-CH((CH₂)ₐₐP¹)((CH₂)_{bb}P²) I*i

—X-alkyl-CHP¹CHP²—CₐₐH₂ₐₐ₊₁ I*k

In the formulae:

alkyl denotes a single bond or a C₁-C₁₂ linear or branched alkylene, wherein one or more CH₂ groups thereof not adjacent to one another may be replaced by —C(R^{x})═C(R^{x})—, —C≡C—, —N(R^{x})—, —O—, —S—, —CO—, —CO—O—, —O—CO— or —O—CO—O-independently of one another so that atoms of oxygen and/or sulfur are not directly bonded to one another, wherein one or more hydrogen atoms thereof may be replaced by F, Cl or CN, and wherein R^{x} is as defined above and preferably denotes R⁰ as defined above,

aa and bb each independently denote 0, 1, 2, 3, 4, 5 or 6,

X has one of the meanings defined for X′, and

P¹ to P⁵ each independently have one of the meanings defined for P above.

The polymerizable compounds are known to those skilled in the art and prepared by methods described in standard organic chemistry books such as, for example, Methoden der organischen Chemie [Methods of Organic Chemistry] edited by Houben-Weyl, Thieme-Verlag, Stuttgart. Polymerizable acrylates and methacrylates of formula I may be synthesized in accordance with the method described in U.S. Pat. No. 5,723,066. Specific examples will be illustrated in Examples.

In the simplest case, the compound may be synthesized by esterifying or etherifying a commercially available diol represented by the general formula HO-L-W-(M-Z)ᵢ—N—OH (in which L, M, N, W, Z and i are as defined above) such as, for example, l-(3-hydroxyphenyl)phenyl-3-ol, in the presence of a dehydrating agent such as dicyclohexylcarbodiimide (DCC) using, for example, the corresponding acid, acid derivative or halogenated compound containing Group P, for example, (meth)acryloyl chloride or (meth)acrylic acid.

For example, one of the specific examples of more preferred polymerizable compound (C) is divinylbenzene. Still more preferably, m-divinylbenzene, p-divinylbenzene or a mixture thereof may be used.

The other specific examples of more preferred polymerizable compound (C) are methacrylic acid derivatives represented by the following formulae:

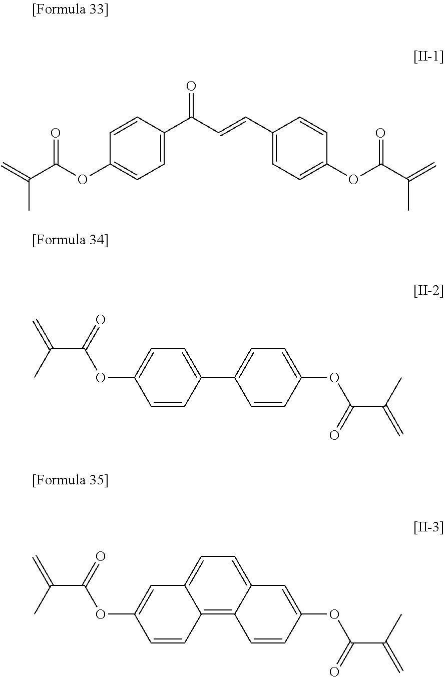

[Photopolymerization Initiator (D)]

The liquid crystal composition of the present invention may include a photopolymerization initiator (D).

The photopolymerization initiators include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes and coumarins.

Preferred examples of commercially available photocleavable radical photopolymerization initiators include “IRGACURE 651”, “IRGACURE 184”, “IRGACURE 819”, “IRGACURE 907”, “IRGACURE 1870” (CGI-403/IRGACURE 184=7/3 mixed initiator), “IRGACURE 500”, “IRGACURE 369”, “IRGACURE 1173”, “IRGACURE 2959”, “IRGACURE 4265”, “IRGACURE 4263”, “IRGACURE 127” and “OXE01” manufactured by BASF; “KAYACURE DETX-S”, “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC” and “KAYACURE MCA” manufactured by Nippon Kayaku Co., Ltd.; “ESACURE (KIP100F, KB1, EB3, BP, X33, KT046, KT37, KIP150, TZT)” manufactured by Sartomer; and combinations thereof.

[Applications]

The liquid crystal composition of the present invention contains preferably 5 to 90% by weight, more preferably 10 to 85% by weight, and most preferably 20 to 80% by weight of cyclohexane compound (A).

The liquid crystal composition of the present invention contains preferably 5 to 90% by weight, more preferably 10 to 85% by weight, and most preferably 20 to 80% by weight of liquid crystal compound (B).

The liquid crystal composition of the present invention contains preferably less than 5% by weight, more preferably less than 3% by weight, and particularly preferably less than 2% by weight of polymerizable compound (C).

The content of photopolymerization initiator (D) in the liquid crystal composition of the present invention is preferably less than 8% by weight of the composition, and more preferably 1 to 5% by weight, for the purpose of polymerizing the polymerizable compounds contained in the composition while avoiding excessive increase of the number of initiation points.

The components described above may be added and mixed together by conventional procedures.

The liquid crystal composition of the invention is suited for electrooptic applications. In particular, it is suitably used in liquid crystal displays (LCDs) based on polymer sustained alignment (PSA) technique, and is more suitably used in liquid crystal displays (LCDs) based on PI-less IPS/FFS technique. It may be sealed in a liquid crystal cell to make an electrooptic display device.

The PSA technique and the PI-less IPS/FFS technique will be described below.

### Embodiment 1: Liquid Crystal Display Having Conventional Alignment Films Such as Polyimide (PI)

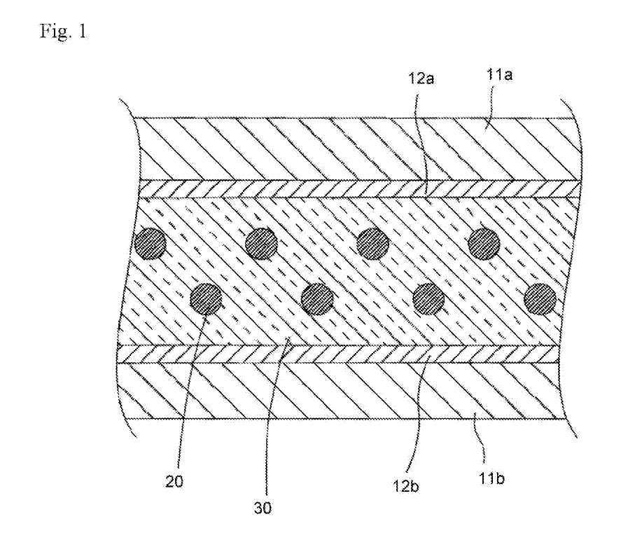

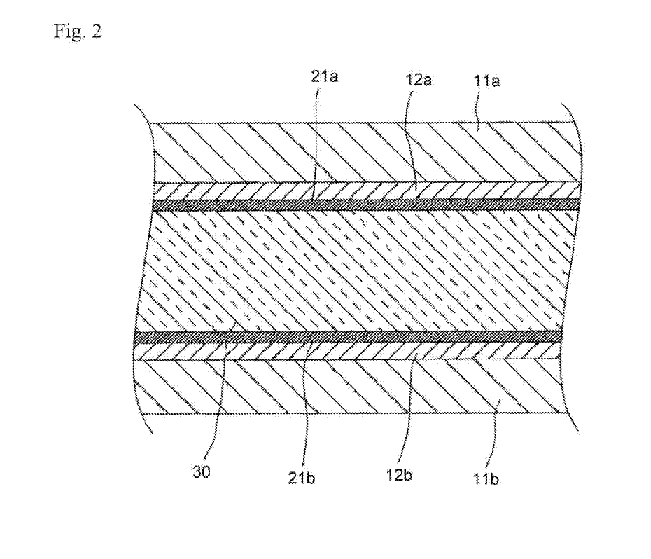

Embodiment 1 will be described with reference to FIGS. 1 and 2. In this embodiment, a liquid crystal display (a liquid crystal display device) having a panel liquid crystal cell having conventional alignment films will be illustrated.

[Liquid Crystal Display]

The liquid crystal display according to this embodiment may be used in the displays and monitors of, among others, television receivers, personal computers, tablet terminals and mobile phones.

The liquid crystal display is equipped with a panel liquid crystal cell (a liquid crystal panel). The liquid crystal display may be any of transmission type, reflection type or other type. In the case of transmission type, the liquid crystal display is further equipped with a backlight device (not shown), which is disposed on the backside of the liquid crystal cell (on the array substrate side described later) and supplies light to the liquid crystal cell. In the case of reflection type, the liquid crystal display is further equipped with a reflective plate, which is disposed on the backside of the liquid crystal cell and reflects external light to the liquid crystal cell. Onto the liquid crystal cell, such members as a polarizer and phase plate, which are not shown, are stacked.

[Liquid Crystal Cell]

As illustrated in FIGS. 1 and 2, the liquid crystal cell contains a pair of substrates 11a and 11b, the major surfaces of which are disposed so as to face each other, and a liquid crystal layer 30 residing between substrates 11a and 11b and containing a liquid crystal material that changes its optical properties upon application of voltage.

Substrates 11a and 11b each include a glass plate superior in transmission made of such a material as alkali-free glass or quartz glass. Plural films are stacked on each glass plate by known techniques such as photolithography.

[Pixel Electrode Substrate]

Of the pair of substrates 11a and 11b, substrate 11b is a pixel electrode substrate (an array substrate, an active matrix substrate, an element substrate) 11b. Although the details are not shown in the drawings, pixel electrode substrate 11b is equipped with a switching element (for example, TFT) connected to a source wire and a gate wire perpendicular to each other, a pixel electrode connected to the switching element, and the like. For the pixel electrodes, for example, transparent conductive materials such as indium tin oxide (ITO) and indium zinc oxide (IZO) are used. Where necessary, other components such as projections and depressions (alignment controlling structures) constituted of fine linear protrusions (bank-like structures) and slits (groove-like structures) may be formed on pixel electrode substrate 11b.

(Counter Electrode Substrate)

Of the pair of substrates 11a and 11b, substrate 11a is a counter electrode substrate 11a. In the present embodiment, a counter electrode (a common electrode) is disposed on counter electrode substrate 11a. Similarly to the pixel electrode, a transparent conductive material such as ITO and IZO is used for the counter electrode. Although the details are not shown in the drawings, counter electrode substrate 11a in the present embodiment is a color filter substrate (a CF substrate) equipped with, in addition to the counter electrode (the common electrode), a color filter having colored portions such as R (red), G (green) and B (blue) in a predetermined arrangement. Where necessary, projections and depressions (alignment controlling structures) constituted of linear protrusions and slits may be formed also on counter electrode substrate 11a. Counter electrode substrate 11a does not necessarily have a color filter. The liquid crystal display may be in a color filter-on-array structure having a color filter on pixel electrode substrate 11b, or may be a monochromatic display having no color filters. The two types of electrodes for applying a voltage to the liquid crystal layer are not necessarily formed on separate substrates. For example, a configuration may be such that a common electrode is formed on pixel electrode substrate 11b.

(Sealing Agent)

A sealing agent (not shown) is disposed between substrates 11a and 11b so as to enclose and seal liquid crystal layer 30 while maintaining a cell gap corresponding to the thickness of liquid crystal layer 30. By the sealing agent, substrates 11a and 11b are bound together.

Any conventional sealing agent may be used. For example; thermosetting, UV-curable, or UV-curable thermosetting agents containing resins such as epoxy resins and acrylic resins may be preferably used.

(Liquid Crystal Layer)

Liquid crystal layer 30 contains the liquid crystal composition described above. The liquid crystal material in the liquid crystal composition has a property of being aligned in a specific direction, and the alignment is controlled by the application of a threshold or higher voltage. In liquid crystal layer 30, the liquid crystal alignment mode in the absence of voltage application is appropriately selected from the known modes such as, for example, TN mode, IPS mode, FFS mode and VA mode (including MVA mode) described above.

(Alignment Film)

In the liquid crystal cell according to Embodiment 1, as illustrated in FIG. 1, conventional alignment films 12a and 12b for aligning liquid crystal molecules contained in the liquid crystal layer are disposed on the inner side of substrates 11a and 11b, respectively. Known materials may be used as the alignment films. From the viewpoint of thermal stability and film formability, it is preferable to make the films with a polymer compound including polyimide, polyamide or polysiloxane.

Such conventional alignment films are not necessarily disposed on both substrates 11a and 11b, and may be formed on either one of the substrates.

Alignment films 12a and 12b are selected appropriately from various alignment films such as vertical alignment film, horizontal alignment film and photoalignment film depending upon the purpose. They are subjected to such an appropriate treatment as rubbing alignment treatment or photoalignment treatment before use.

The alignment treatment, if applied, is preferably photoalignment treatment. Photoalignment treatment permits reduction of dust generation and structural damages as compared to rubbing alignment treatment. To make photoalignment treatment available, it is preferable that alignment films 12a and 12b contain photoalignable functional groups. Photoalignable functional groups are functional groups which react (for example, undergo photoisomerization) when irradiated with predetermined light (such as polarized UV light) and change their structures. Introduction of such a photoalignable functional group into the side chain may impart optical alignability to the alignment films while maintaining the main chain structure. From the viewpoints of the introducing facility of the functional group to the side chain and the reactivity thereof, for example, it is preferable that the photoalignable functional group be at least one selected from the group consisting of cinnamate group, chalconyl group, coumarin group, azobenzene group, etc.

(Alignment Controlling Layer)

In the present embodiment, as illustrated in FIG. 2, alignment controlling layers 21a and 21b are disposed on both of the surfaces facing liquid crystal layer 30 of pixel electrode substrate 11b and counter electrode substrate 11a, respectively.

Alignment controlling layers 21a and 21b are polymer layers formed selectively at interface between liquid crystal layer 30 and alignment films 12a and 12b by the polymerization of polymerizable monomer 20 and optionally any photopolymerization initiator contained in the liquid crystal composition. The “interface between liquid crystal layer 30 and alignment films 12a and 12b” is a boundary between liquid crystal layer 30 and the structure that is the closest to liquid crystal layer 30 among the structures disposed on alignment films 12a and 12b. Alignment controlling layers 21a and 21b are disposed in direct contact with liquid crystal layer 30.

In the present embodiment, the liquid crystal alignment mode in liquid crystal layer 30 in the absence of voltage application is regulated by the alignment controlling layers and the alignment films.

### Embodiment 2: Liquid Crystal Display Having No Conventional Alignment Film

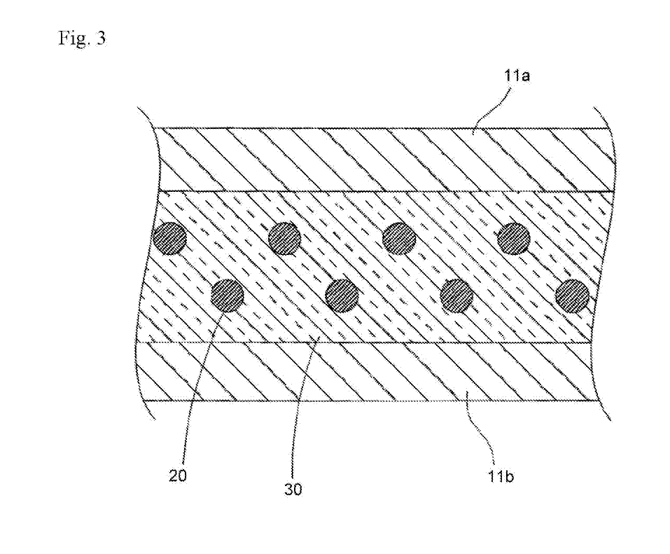

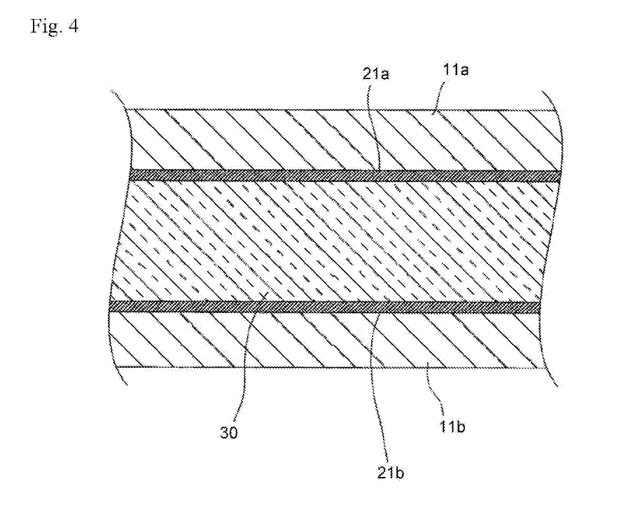

Embodiment 2 will be described with reference to FIGS. 3 and 4. In this embodiment, a liquid crystal display which has no conventional alignment films (a liquid crystal display free from conventional alignment film) will be illustrated. As already mentioned, the conventional alignment films in the present specification are alignment films formed by applying a resin such as polyimide onto a substrate.

[Liquid Crystal Display]

The liquid crystal display according to this embodiment may be used in displays and monitors of, among others, television receivers, personal computers, tablet terminals and mobile phones.

The liquid crystal display is equipped with a panel liquid crystal cell (a liquid crystal panel). The liquid crystal display may be any of transmission type, reflection type or other type. In the case of transmission type, the liquid crystal display is further equipped with a backlight device (not shown), which is disposed on the backside of the liquid crystal cell (on the array substrate side described later) and supplies light to the liquid crystal cell. In the case of reflection type, the liquid crystal display is further equipped with a reflective plate, which is disposed on the backside of the liquid crystal cell and reflects external light to the liquid crystal cell. Onto the liquid crystal cell, such members as a polarizer and a phase plate, which are not shown, are stacked.

[Liquid Crystal Cell]

The liquid crystal cell may be of known configuration without any conventional alignment film. As illustrated in FIGS. 3 and 4, the liquid crystal cell contains a pair of substrates 11a and 11b, the major surfaces of which are disposed so as to face each other, and a liquid crystal layer 30 residing between substrates 11a and 11b and containing a liquid crystal material that changes its optical properties upon application of voltage.

Substrates 11a and 11b each include a glass plate superior in transmission made of such a material as alkali-free glass or quartz glass. Plural films are stacked on each glass plate by known techniques such as photolithography.

[Pixel Electrode Substrate]

Of the pair of substrates 11a and 11b, substrate 11b is a pixel electrode substrate (an array substrate, an active matrix substrate, an element substrate) 11b. Although the details are not shown in the drawings, pixel electrode substrate 11b is equipped with a switching element (for example, TFT) connected to a source wire and a gate wire perpendicular to each other, a pixel electrode connected to the switching element, and the like. For the pixel electrodes, for example, transparent conductive materials such as indium tin oxide (ITO) and indium zinc oxide (IZO) are used. Where necessary, other components such as projections and depressions (alignment controlling structures) constituted of fine linear protrusions (bank-like structures) and slits (groove-like structures) may be formed on pixel electrode substrate 11b.

(Counter Electrode Substrate)

Of the pair of substrates 11a and 11b, substrate 11a is a counter electrode substrate 11a. In the present embodiment, a counter electrode (a common electrode) is disposed on counter electrode substrate 11a. Similarly to the pixel electrode, a transparent conductive material such as ITO and IZO is used for the counter electrode. Although the details are not shown in the drawings, counter electrode substrate 11a in the present embodiment is a color filter substrate (a CF substrate) equipped with, in addition to the counter electrode (the common electrode), a color filter having colored portions such as R (red), G (green) and B (blue) in a predetermined arrangement. Where necessary, projections and depressions (alignment controlling structures) constituted of linear protrusions and slits may be formed on counter electrode substrate 11a. Counter electrode substrate 11a does not necessarily have a color filter. The liquid crystal display may be in a color filter-on-array structure having a color filter on pixel electrode substrate 11b, or may be a monochromatic display having no color filters. The two types of electrodes for applying a voltage to the liquid crystal layer are not necessarily formed on separate substrates. For example, a configuration may be such that a common electrode is formed on pixel electrode substrate 11b.

(Sealing Agent)

A sealing agent (not shown) is disposed between substrates 11a and 11b so as to enclose and seal liquid crystal layer 30 while maintaining a cell gap corresponding to the thickness of liquid crystal layer 30. By the sealing agent, substrates 11a and 11b are bound together.

Any conventional sealing agent may be used. For example, thermosetting, UV-curable, or UV-curable thermosetting agents containing resins such as epoxy resins and acrylic resins may be preferably used.

(Liquid Crystal Layer)

Liquid crystal layer 30 contains the liquid crystal composition described later. The liquid crystal material in the liquid crystal composition has a property of being aligned in a specific direction, and the alignment is controlled by the application of a threshold or higher voltage. In liquid crystal layer 30, the liquid crystal alignment mode in the absence of voltage application is appropriately selected from the known modes such as, for example, TN mode, IPS mode, FFS mode and VA mode (including MVA mode) described above.

(Alignment Controlling Layer)

In the present embodiment, as illustrated in FIG. 4, alignment controlling layers 21a and 21b are disposed on both of the surfaces facing liquid crystal layer 30 of pixel electrode substrate 11b and counter electrode substrate 11a, respectively.

Alignment controlling layers 21a and 21b are polymer layers formed selectively at interface between liquid crystal layer 30 and substrates 11a and 11b by the polymerization of polymerizable monomer 20 and optionally any photopolymerization initiator contained in the liquid crystal composition described later. The “interface between liquid crystal layer 30 and substrates 11a and 11b” is a boundary between liquid crystal layer 30 and the structure that is the closest to liquid crystal layer 30 among the structures disposed on substrates 11a and 11b. Alignment controlling layers 21a and 21b are disposed in direct contact with liquid crystal layer 30.

In the present embodiment, there are no conventional alignment films such as polyimides formed on substrates 11a and 11b. The liquid crystal alignment mode in liquid crystal layer 30 in the absence of voltage application is regulated by, among others, the alignment controlling layers and the alignment controlling structures.

### EXAMPLES

The present invention will be described in more detail with reference to the following Examples; however, it should not be understood that the scope of the invention is limited thereto.

Percentages are on weight basis. All temperatures are Celsius. N-I transition point indicates nematic to isotropic transition temperature, Δn optical anisotropy (589 nm, 25° C.), and A dielectric anisotropy.

The structure and abbreviation of cyclohexane compounds, liquid crystal compounds and polymerizable compounds used in Examples are as follows.

Cyclohexane Compound (A) of Formula [I]

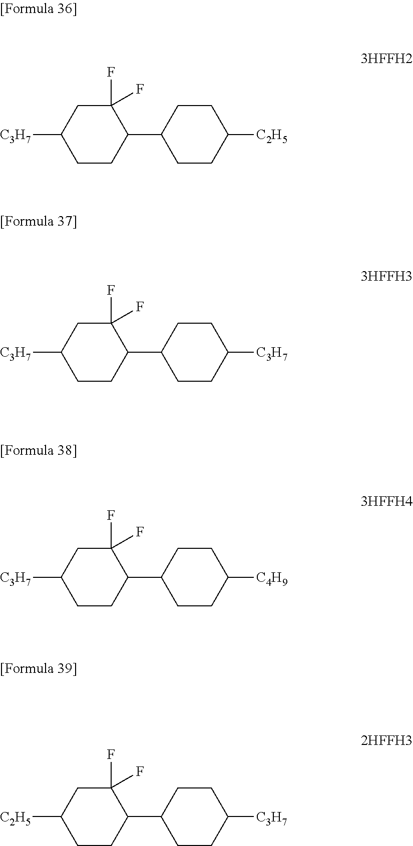

Polymerizable Compound (C) of Formula [II]

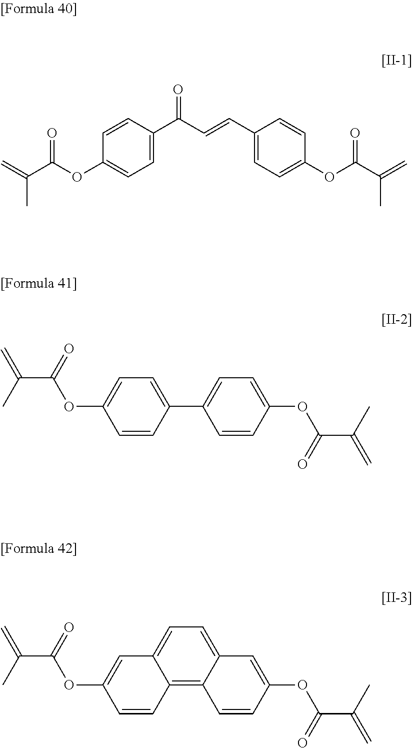

Comparative Cyclohexane Compounds

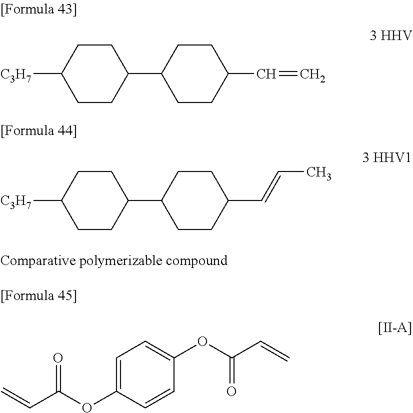

### Synthetic Example

Cyclohexane compound 2HFFH3 above was synthesized in the following manner.

2-Chloro-5-ethylhexanone and 4-n-propylcyclohexyl magnesium chloride were reacted in diethyl ether or THF solvent in the presence of zinc chloride and copper (II) acetylacetonate, and the product was treated by usual procedures to give 4-ethyl-4′-n-propylbi(cyclohexane)-2-one. Δn=0.059 m/z=250

0.5 Gram of 4-ethyl-4′-n-propylbi(cyclohexane)-2-one obtained above was dissolved into 8 ml of dichloromethane, and at 4° C., 0.5 g of DAST was added thereto. Thereafter, the resultant mixture was stirred at room temperature for 38 hours, extracted with toluene, and subjected to silica gel column treatment (heptane/ethyl acetate=5/1) to obtain 0.2 g of cyclohexane compound 2HFFH3. Δn=0.062 m/z=272

The other cyclohexane compounds above can also be synthesized in the same manner as this synthetic example.

### Example I and Comparative Examples II and III

In the following description of Examples and Comparative Examples, for the sake of simplicity, a system which contains a liquid crystal compound and a polymerizable compound will be referred to as “liquid crystal composition”, and a system which is free from a polymerizable compound will be referred to as “liquid crystal material”.

(1.1) Liquid Crystal Material

Negative liquid crystal materials I and III (N-I transition point: 82° C., Δn=0.10, Δε=−2.5) were prepared by adding the above cyclohexane compound 3HFFH3 to a mother liquid crystal having a composition shown in Table 1-1. Separately, a liquid crystal material II (N-I transition point: 81° C., Δn=0.10, Δε=−2.5) was prepared by adding 3HHV, which is outside the scope of the present invention, to a mother liquid crystal having a composition shown in Table 1-1.

(1.2) Liquid Crystal Composition Containing Polymerizable Compound (C) of Formula [II]

0.3 Part by weight of polymerizable compound [II-1] was dissolved in 100 parts by weight of negative liquid crystal material I described in (1.1) above. After a predetermined amount of polymerizable compound [II-1] was added to liquid crystal material I, the resultant mixture was allowed to stand in an oven at 50° C. for approximately 20 minutes to let polymerizable compound [II-1] dissolve, and the solution was allowed to stand in a dark place (20° C.) overnight to make sure that polymerizable compound [II-1] was completely dissolved. The resultant solution is liquid crystal composition I (Example) within the scope of the present invention. Separately, 0.3 part by weight of polymerizable compound [II-A], which is outside the scope of the present invention, was dissolved in each of liquid crystal materials II and III to obtain liquid crystal compositions II and III (Comparative Examples), which are outside the scope of the present invention.

(1.3) Steps for Fabricating PSA Liquid Crystal Cell

Two glass plates having a pair of ITO electrodes were provided, and a vertical alignment film of polyimide was formed on one surface of each glass plate. The polyimide film was prebaked at 90° C. for 5 minutes and was post-baked at 200° C. for 40 minutes. A seal was drawn on one of the substrates using a UV-curable thermosetting sealing agent. Subsequently, negative liquid crystal composition I containing polymerizable compound [II-1] was dropped onto the substrate, and the other substrate was laminated thereon. The stack was allowed to stand in an oven at 100° C. for 40 minutes, and the sealing agent was completely cured to make a liquid crystal cell. Subsequently, 10 V square wave voltages (60 Hz) were applied to the liquid crystal cell and the liquid crystal cell was irradiated with UV light for 20 minutes to polymerize polymerizable compound [II-1] to form a polymer layer. The UV light was generated using black light “FHF-32 BLB” manufactured by TOSHIBA CORPORATION. By the steps described above, a PSA liquid crystal cell was fabricated. Separately, comparative PSA liquid crystal cells were fabricated in the similar manner using liquid crystal compositions II and III, which are outside the scope of the present invention.

(1.4) Measurement of Voltage Holding Ratio (VHR)

The VHR of the above PSA liquid crystal cells was measured. The measurement was performed before and after the formation of a polymer layer by UV irradiation. The apparatus used and measurement conditions thereof were as follows.

Apparatus: Model 6254 VHR measurement system manufactured by TOYO Corporation.
Measurement conditions: applied voltage of 5 V, frame time of 16.6 ms, at a temperature of 70° C.

The results are shown in Table 1-2.

TABLE 1

| | I | II | III | Contents |
|---|---|---|---|---|
| Cyclohexane | 3HFFH3 | 3HHV | 3HFFH3 | 25% |
| compound | | | | |
| Polymerizable compound | 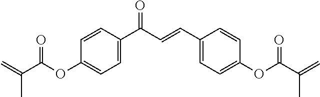 | 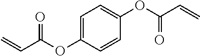 | 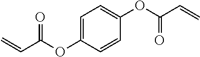 | 0.3 Part by weight |

| | | |
|---|---|---|
| Mother liquid crystal | 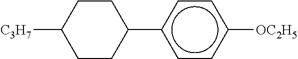 | 20% |
| | 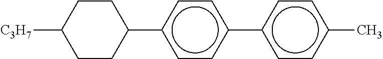 | 15% |
| | 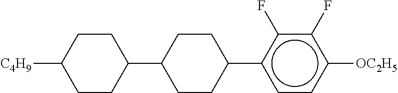 | 15% |
| | 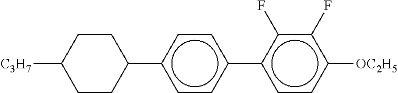 | 20% |
| | 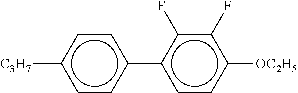 | 5% |

TABLE 1-2

| | | VHR(%) | |
|---|---|---|---|
| | Liquid crystal | Before formation | After formation |
| | composition | of polymer layer | of polymer layer |
| Inventive PSA | I | 99.5 | 99.4 |
| liquid crystal cell | | | |
| Comparative PSA | II | 99.5 | 97.8 |
| liquid crystal cell | | | |
| Comparative PSA | III | 99.5 | 98.1 |
| liquid crystal cell | | | |

As demonstrated by the above tables, the VHR of the inventive PSA liquid crystal cell was not reduced even after UV light irradiation for forming a polymer layer attributable to the use of the inventive liquid crystal composition containing cyclohexane compound of formula [I].

### Example IV and Comparative Example V

(2.1) Liquid Crystal Material

Negative liquid crystal material IV (N-I transition point: 85° C., Δn=0.10, Δε=−2.5) was prepared by adding the above cyclohexane compound 3HFFH2 to a mother liquid crystal having a composition shown in Table 2-1. Separately, liquid crystal material V (N-I transition point: 85° C., Δn=0.10, Δε=−2.5) was prepared by adding 3HHV, which is outside the scope of the present invention, to a mother liquid crystal having a composition shown in Table 2-1.

(2.2) Liquid Crystal Composition Containing Polymerizable Compound (C) of Formula [II]

0.3 Part by weight of polymerizable compound [II-2] was dissolved in 100 parts by weight of negative liquid crystal material IV described in (2.1) above. After a predetermined amount of polymerizable compound [II-2] was added to liquid crystal material IV, the resultant mixture was allowed to stand in an oven at 50° C. for approximately 20 minutes to let polymerizable compound [II-2] dissolve, and the solution was allowed to stand in a dark place (20° C.) overnight to make sure that polymerizable compound [II-2] was completely dissolved. The resultant solution is liquid crystal composition IV (Example) within the scope of the present invention. Separately, 0.3 part by weight of polymerizable compound [II-2] was dissolved in liquid crystal material V to obtain liquid crystal composition V (Comparative Example).

(2.3) Steps for Fabricating PSA Liquid Crystal Cell

Two glass plates having a pair of ITO electrodes were provided, and a vertical alignment film of polyimide was formed on one surface of each glass plate. The polyimide film was prebaked at 90° C. for 5 minutes and was post-baked at 200° C. for 40 minutes. A seal was drawn on one of the substrates using a UV-curable thermosetting sealing agent. Subsequently, negative liquid crystal composition IV containing polymerizable compound [II-2] was dropped onto the substrate, and the other substrate was laminated thereon. The stack was allowed to stand in an oven at 100° C. for 40 minutes, and the sealing agent was completely cured to make a liquid crystal cell. Subsequently, 10 V square wave voltages (60 Hz) were applied to the liquid crystal cell and the liquid crystal cell was irradiated with UV light for 30 minutes to polymerize polymerizable compound [II-2] to form a polymer layer. The UV light was generated using black light “FHF-32 BLB” manufactured by TOSHIBA CORPORATION. By the steps described above, a PSA liquid crystal cell was fabricated. Separately, a comparative PSA liquid crystal cell was fabricated in the similar manner using liquid crystal composition V, which is outside the scope of the present invention.

(2.4) Measurement of Voltage Holding Ratio (VHR)

The VHR of the above PSA liquid crystal cells was measured. The measurement was performed before and after the formation of a polymer layer by UV irradiation. The apparatus used and measurement conditions thereof were as follows.

Apparatus: Model 6254 VHR measurement system manufactured by TOYO Corporation.
Measurement conditions: applied voltage of 5 V, frame time of 16.6 ms, at a temperature of 70° C.

The results are shown in Table 2-2.

TABLE 3

| | IV | V | Contents |
|---|---|---|---|
| Cyclohexane | 3HFFH2 | 3HHV | 40% |
| compound | | | |
| Polymerizable compound | 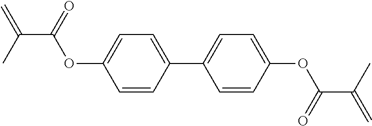 | 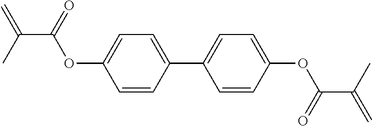 | 0.3 Part by weight |

| | | |
|---|---|---|
| Mother liquid crystal | 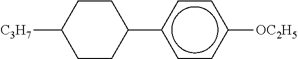 | 4% |
| | 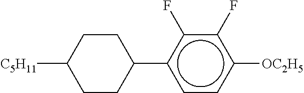 | 14% |
| | 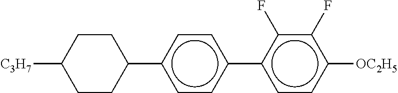 | 20% |
| | 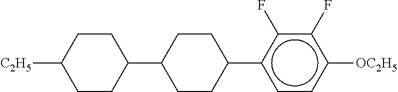 | 8% |
| | 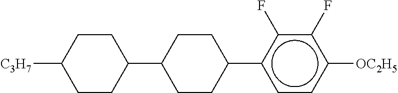 | 4% |
| | 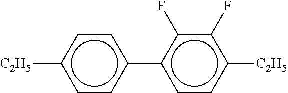 | 10% |

TABLE 2-2

| | VHR(%) | |
|---|---|---|
| | Before formation | After formation |
| | of polymer layer | of polymer layer |
| Inventive PSA | 99.5 | 99.4 |
| liquid crystal cell | | |
| Comparative PSA | 99.5 | 97.2 |
| liquid crystal cell | | |

As demonstrated by the above tables, the VHR of the inventive PSA liquid crystal cell was not reduced even after UV light irradiation for forming a polymer layer attributable to the use of the inventive liquid crystal composition containing cyclohexane compound of formula [I]. The similar advantageous effects as those in Example I were obtained also when the polymerizable compound for forming a polymer layer was changed from polymerizable compound [II-1] to polymerizable compound [II-2].

### Example VI and Comparative Example VII

(3.1) Liquid Crystal Material

Negative liquid crystal material VI (N-I transition point: 82° C., Δn=0.10, Δε=−2.5) was prepared by adding the above cyclohexane compound 3HFFH4 to a mother liquid crystal having a composition shown in Table 3-1. Separately, liquid crystal material VII (N-I transition point: 81° C., Δn=0.10, Δε=−2.5) was prepared by adding 3HHV1, which is outside the scope of the present invention, to a mother liquid crystal having a composition shown in Table 3-1.

(3.2) Liquid Crystal Composition Containing Polymerizable Compound (C) of Formula [II]

0.3 Part by weight of polymerizable compound [II-3] was dissolved in 100 parts by weight of negative liquid crystal material VI described in (3.1) above. After a predetermined amount of polymerizable compound [II-3] was added to liquid crystal material VI, the resultant mixture was allowed to stand in an oven at 50° C. for approximately 20 minutes to let polymerizable compound [II-3] dissolve, and the solution was allowed to stand in a dark place (20° C.) overnight to make sure that polymerizable compound [II-3] was completely dissolved. The resultant solution is liquid crystal composition VI (Example) within the scope of the present invention. Separately, 0.3 part by weight of polymerizable compound [II-3] was dissolved in liquid crystal material VII to obtain liquid crystal composition VII (Comparative Example), which is outside the scope of the present invention.

(3.3) Steps for Fabricating PSA Liquid Crystal Cell

Two glass plates having a pair of ITO electrodes were provided, and a vertical alignment film of polyimide was formed on one surface of each glass plate. The polyimide film was prebaked at 90° C. for 5 minutes and was post-baked at 200° C. for 40 minutes. A seal was drawn on one of the substrates using a UV-curable thermosetting sealing agent. Subsequently, negative liquid crystal composition VI containing polymerizable compound [II-3] was dropped onto the substrate, and the other substrate was laminated thereon. The stack was allowed to stand in an oven at 100° C. for 40 minutes, and the sealing agent was completely cured to make a liquid crystal cell. Subsequently, 10 V square wave voltages (60 Hz) were applied to the liquid crystal cell and the liquid crystal cell was irradiated with UV light for 20 minutes to polymerize polymerizable compound [II-3] to form a polymer layer. The UV light was generated using black light “FHF-32 BLB” manufactured by TOSHIBA CORPORATION. By the steps described above, a PSA liquid crystal cell was fabricated. Separately, a comparative PSA liquid crystal cell was fabricated in the similar manner using liquid crystal composition VII, which is outside the scope of the present invention.

(3.4) Measurement of Voltage Holding Ratio (VHR)

The VHR of the above PSA liquid crystal cells was measured. The measurement was performed before and after the formation of a polymer layer by UV irradiation. The apparatus used and measurement conditions thereof were as follows.

Apparatus: Model 6254 VHR measurement system manufactured by TOYO Corporation.
Measurement conditions: applied voltage of 5 V, frame time of 16.6 ms, at a temperature of 70° C.

The results are shown in Table 3-2.

TABLE 5

| | VI | VII | Contents |
|---|---|---|---|
| Cyclohexane | 3HFFH4 | 3HHV1 | 30% |
| compound | | | |
| Polymerizable compound | 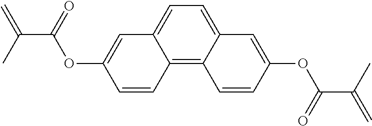 | 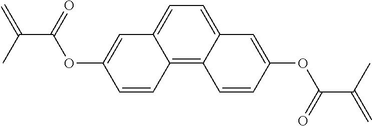 | 0.3 Part by weight |

| | | |
|---|---|---|
| Mother liquid crystal | 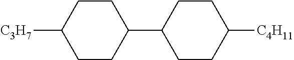 | 11% |
| | 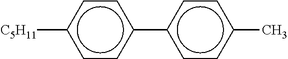 | 10% |
| | 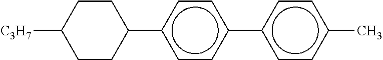 | 10% |
| | 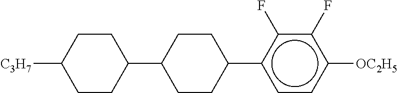 | 12% |
| | 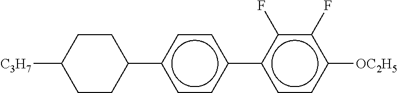 | 27% |

TABLE 3-2

| | | VHR(%) | |
|---|---|---|---|
| | Liquid crystal | Before formation | After formation |
| | composition | of polymer layer | of polymer layer |
| Inventive PSA | VI | 99.5 | 99.4 |
| liquid crystal cell | | | |
| Comparative PSA | VII | 99.5 | 98.4 |
| liquid crystal cell | | | |

As demonstrated by the above tables, the VHR of the inventive PSA liquid crystal cell was not reduced even after UV light irradiation for forming a polymer layer attributable to the use of the inventive liquid crystal composition containing cyclohexane compound of formula [I]. The similar advantageous effects as those provided by the inventive liquid crystal compositions I and IV were obtained also when the polymerizable compound for forming a polymer layer was changed from polymerizable compound [II-1] or [II-2] to polymerizable compound [II-3].

### Example VIII and Comparative Example IX

(4.1) Liquid Crystal Material

Negative liquid crystal material VIII (N-I transition point: 82° C., Δn=0.10, Δε=−2.5) was prepared by adding the above cyclohexane compound 3HFFH3 to a mother liquid crystal having a composition shown in Table 4-1. Separately, liquid crystal material IX (N-I transition point: 81° C., Δn=0.10, Δε=−2.5) was prepared by adding 3HHV, which is outside the scope of the present invention, to a mother liquid crystal having a composition shown in Table 4-1.

(4.2) Liquid Crystal Composition Including Polymerizable Compound (C) of Formula [II]

1.0 Part by weight of polymerizable compound [II-1] was dissolved in 100 parts by weight of negative liquid crystal material VIII described in (4.1) above. After a predetermined amount of polymerizable compound [II-1] was added to liquid crystal material VIII, the resultant mixture was allowed to stand in an oven at 50° C. for approximately 20 minutes to let polymerizable compound [II-1] dissolve, and the solution was allowed to stand in a dark place (20° C.) overnight to make sure that the polymerizable compound [II-1] was completely dissolved. The resultant solution is liquid crystal composition VIII (Example) within the scope of the present invention. Separately, 1.0 part by weight of polymerizable compound [II-1] was dissolved in liquid crystal material IX to obtain liquid crystal composition IX (Comparative Example), which is outside the scope of the present invention.

(4.3) Steps for Fabricating PI-Less IPS Liquid Crystal Cell

A glass plate having an ITO electrode, and a counter glass plate having no ITO electrode were provided. A seal was drawn on one of the substrates using a UV-curable thermosetting sealing agent. Subsequently, negative liquid crystal composition VIII containing polymerizable compound [II-1] was dropped onto the substrate, and the other substrate was laminated thereon. The stack was allowed to stand in an oven at 100° C. for 40 minutes, and the sealing agent was completely cured. to make a liquid crystal cell. Subsequently, the liquid crystal cell was irradiated with polarized UV light for 20 minutes while being heated at 90° C. or above, in order to polymerize polymerizable compound [II-1] to form a horizontal alignment polymer layer. The polarized UV light was generated using ultrahigh pressure mercury lamp manufactured by USHIO INC. in combination with a polarizer. By the steps described above, a PI-less IPS liquid crystal cell was fabricated. Separately, a comparative PI-less IPS liquid crystal cell was fabricated in the similar manner using liquid crystal composition IX, which is outside the scope of the present invention.

(4.4) Measurement of Voltage Holding Ratio (VHR)

The VHR of the above PI-less IPS liquid crystal cells was measured. The measurement was performed before and after the formation of a polymer layer by UV irradiation. The apparatus used and measurement conditions thereof were as follows.

Apparatus: Model 6254 VHR measurement system manufactured by TOYO Corporation.
Measurement conditions: applied voltage of 5 V, frame time of 16.6 ms, at a temperature of 70° C.

The results are shown in Table 4-2.

TABLE 7

| | VIII | IX | Contents |
|---|---|---|---|
| Cyclohexane | 3HFFH3 | 3HHV | 25% |
| compound | | | |
| Polymerizable compound | 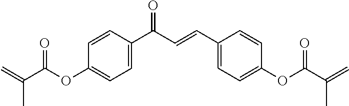 | 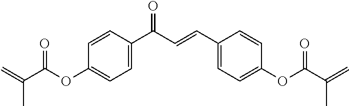 | 1 Part by weight |

| | | |
|---|---|---|
| Mother liquid crystal | 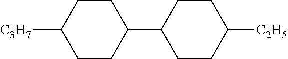 | 10% |
| | 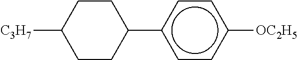 | 10% |
| | 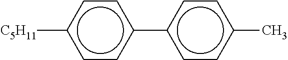 | 13% |
| | 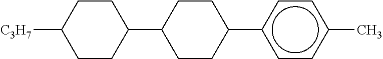 | 2% |
| | 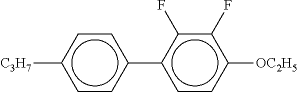 | 5% |
| | 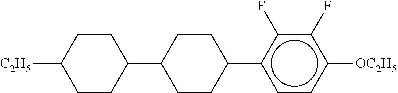 | 12% |
| | 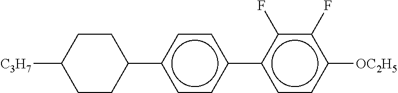 | 23% |

TABLE 4-2

| | | VHR(%) | |
|---|---|---|---|
| | Liquid crystal | Before formation | After formation |
| | composition | of polymer layer | of polymer layer |
| Inventive PI-less | VIII | 99.3 | 99.2 |
| IPS liquid crystal cell | | | |
| Comparative PI-less | IX | 99.3 | 98.1 |
| IPS liquid crystal cell | | | |

As demonstrated by the above tables, the VHR of the inventive PI-less IPS liquid crystal cell was not reduced even after polarized UV light irradiation for forming a horizontal alignment polymer layer attributable to the use of the inventive liquid crystal composition containing cyclohexane compound of formula [I].

### INDUSTRIAL APPLICABILITY

By the present invention, it is now possible to provide a liquid crystal composition which does not cause VHR reduction after UV irradiation for forming a polymer layer, and a liquid crystal display (LCD) with quick response and high light resistance from such a liquid crystal composition.

### REFERENCE SIGNS LIST

11a Counter electrode substrate
11b Pixel electrode substrate
12a Alignment film
12b Alignment film
20 Polymerizable compound (monomer)
21a Alignment controlling layer
21b Alignment controlling layer
30 Liquid crystal layer

1. A liquid crystal composition comprising:
(A) a cyclohexane compound represented by the following formula [I]: 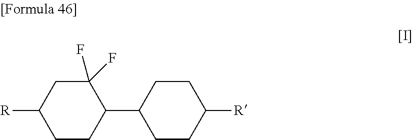
wherein R and R′ are each independently a C₁-C₆ linear alkyl group;
(B) a compound that is different from cyclohexane compound (A) and is a liquid crystal; and
(C) at least one polymerizable compound selected from the group consisting of:
a polymerizable compound represented by the following formula [II]:
[Formula 47]
P¹-Sp¹-E-Sp²-P² [II]
wherein P¹ and P² are the same as or different from one another and are each an acryloyloxy group, a methacryloyloxy group, an acryloylamino group, a methacryloylamino group, a vinyl group or a vinyloxy group,
Sp¹ and Sp² are the same as or different from one another and are each a C₁-C₆ linear, branched or cyclic alkylene group, a C₁-C₆ linear, branched or cyclic alkyleneoxy group, or a direct bond, and
E is a C₁₀-C₃₂ arylene group optionally linked by a single bond, —COCH═CH— or —CH═CHCO—, and
a polymerizable compound represented by the following formula [III]:
[Formula 48]
A-(L-W)ᵢ-(M-Z)ⱼ—(N)ₖ—B [III]
wherein A and B are the same as or different from one another and are each P-Q-, H, halogen, SF₅, NO₂, a carbon group or a hydrocarbon group, with the proviso that at least one of A and B is P-Q-,
P is a polymerizable group,
Q is a spacer group or a single bond,
i quantity of L and k quantity of N are the same as or different from one another and are each 1,3-phenylene, 1,4-phenylene, naphthalene-1,3-diyl, naphthalene-1,6-diyl, naphthalene-2,5-diyl, naphthalene-2,7-diyl, (wherein one or more CH groups of these groups may be substituted with a nitrogen atom), cyclohexane-1,3-diyl (wherein one or more CH₂ groups thereof not adjacent to one another may be substituted with an oxygen atom and/or a sulfur atom), 1,3-cyclohexenylene, piperidine-2,4-diyl, piperidine-2,6-diyl, decahydronaphthalene-2,7-diyl, 1,2,3,4-tetrahydronaphthalene-2,7-diyl or indane-2,4-diyl, with the proviso that all of the above groups may be unsubstituted or mono- or polysubstituted with T, and when i=k=1, either group L or group N may have one of meanings defined for M,
j quantity of M are the same as or different from one another and are each 1,3-phenylene, 1,4-phenylene, naphthalene-1,4-diyl, naphthalene-2,6-diyl (wherein one or more CH groups of these groups may be substituted with a nitrogen atom), cyclohexane-1,4-diyl (wherein one or more CH₂ groups thereof not adjacent to one another may be substituted with an oxygen atom and/or a sulfur atom), 1,4-cyclohexenylene, bicyclo[1.1.1]pentane-1,3-diyl, bicyclo[2.2.2]octane-1,4-diyl, spiro[3.3]heptane-2,6-diyl, piperidine-2,5-diyl, decahydronaphthalene-2,6-diyl, 1,2,3,4-tetrahydronaphthalene-2,6-diyl, indane-2,5-diyl, thiophene-2,5-diyl, fluorene-2,7-diyl or octahydro-4,7-methanoindane-2,5-diyl, with the proviso that all of the above groups may be unsubstituted or mono- or polysubstituted with T and may have one of meanings defined for L,
T is P-Q-, H, OH, halogen, SF₅, NO₂, a carbon group or a hydrocarbon group,
i quantity of W and j quantity of Z are the same as or different from one another and are each —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ—, —CF₂CH₂—, —CH₂CF₂—, —(CF₂)ₙ—, —CH═CH—, —CF═CF—, —C≡C—, —CH═CH—COO—, —OCO—CH═CH—, —CUV or a single bond,
U and V are each independently H or a C₁-C₁₂ alkyl group,
i and k are each independently 0 or 1, with the proviso that i+k>0,
j is 0, 1, 2 or 3, and
n is 1, 2, 3 or 4,
with the proviso that when polymerizable compound (C) includes a polymerizable compound of formula [III], R and R′ in formula [I] for cyclohexane compound (A) are not n-propyl groups at the same time.

2. The liquid crystal composition according to claim 1, further comprising:
(D) a photopolymerization initiator.

3. The liquid crystal composition according to claim 1, wherein polymerizable compound (C) is a polymerizable compound of formula [II].

4. The liquid crystal composition according to claim 3, wherein P¹ and P² in formula [II] are acryloyloxy groups.

5. The liquid crystal composition according to claim 1, wherein polymerizable compound (C) is selected from the group consisting of:

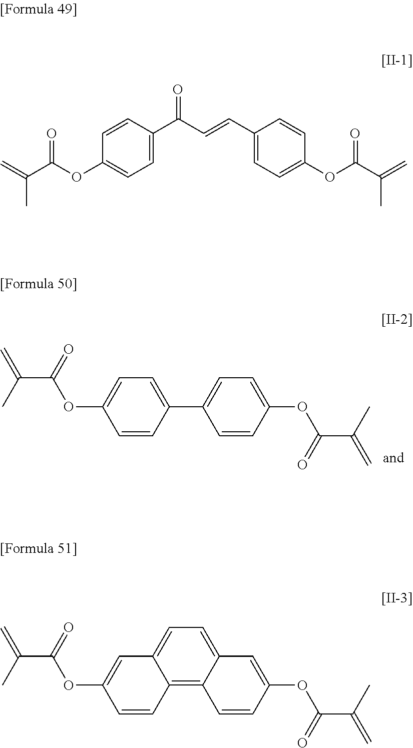

6. The liquid crystal composition according to claim 1, comprising 5 to 90% by weight of cyclohexane compound (A).

7. The liquid crystal composition according to claim 1, comprising 5 to 90% by weight of liquid crystal compound (B).

8. The liquid crystal composition according to claim 1, comprising less than 5% by weight of polymerizable compound (C).

9. The liquid crystal composition according to claim 2, comprising less than 8% by weight of photopolymerization initiator (D).

10. A liquid crystal display comprising:
a pair of substrates,
a liquid crystal layer disposed between the pair of substrates and comprising a liquid crystal composition, and
an alignment controlling layer that is disposed in contact with the liquid crystal layer and controls alignment of the liquid crystal composition,
wherein the liquid crystal composition comprises:
(A) a cyclohexane compound represented by the following formula [I]: 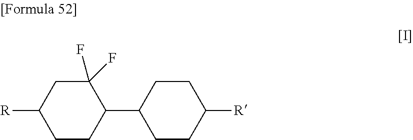
wherein R and R′ are each independently a C₁-C₆ linear alkyl group;
(B) a compound that is different from cyclohexane compound (A) and is a liquid crystal; and
(C) at least one polymerizable compound selected from the group consisting of:
a polymerizable compound represented by the following formula [II]:
[Formula 53]
P¹-Sp¹-E-Sp²-P² [II]
wherein P¹ and P² are the same as or different from one another and are each an acryloyloxy group, a methacryloyloxy group, an acryloylamino group, a methacryloylamino group, a vinyl group or a vinyloxy group,
Sp¹ and Sp² are the same as or different from one another and are each a C₁-C₆ linear, branched or cyclic alkylene group, a C₁-C₆ linear, branched or cyclic alkyleneoxy group, or a direct bond, and
E is a C₁₀-C₃₂ arylene group optionally linked by a single bond, —COCH═CH— or —CH═CHCO—, and
a polymerizable compound represented by the following formula [III]:
[Formula 54]
A-(L-W)ᵢ-(M-Z)ⱼ-(N)ₖ—B [III]
wherein A and B are the same as or different from one another and are each P-Q-, H, halogen, SF₅, NO₂, a carbon group or a hydrocarbon group, with the proviso that at least one of A and B is P-Q-,
P is a polymerizable group,
Q is a spacer group or a single bond,
i quantity of L and k quantity of N are the same as or different from one another and are each 1,3-phenylene, 1,4-phenylene, naphthalene-1,3-diyl, naphthalene-1,6-diyl, naphthalene-2,5-diyl, naphthalene-2,7-diyl (wherein one or more CH groups of these groups may be substituted with a nitrogen atom), cyclohexane-1,3-diyl (wherein one or more CH₂ groups thereof not adjacent to one another may be substituted with an oxygen atom and/or a sulfur atom), 1,3-cyclohexenylene, piperidine-2,4-diyl, piperidine-2,6-diyl, decahydronaphthalene-2,7-diyl, 1,2,3,4-tetrahydronaphthalene-2,7-diyl or indane-2,4-diyl, with the proviso that all of the above groups may be unsubstituted or mono- or polysubstituted with T, and when i=k=1, either group L or group N may have one of meanings defined for M,
j quantity of M are the same as or different from one another and are each 1,3-phenylene, 1,4-phenylene, naphthalene-1,4-diyl, naphthalene-2,6-diyl (wherein one or more CH groups of these groups may be substituted with a nitrogen atom), cyclohexane-1,4-diyl (wherein one or more CH₂ groups thereof not adjacent to one another may be substituted with an oxygen atom and/or a sulfur atom), 1,4-cyclohexenylene, bicyclo[1.1.1]pentane-1,3-diyl, bicyclo[2.2.2]octane-1,4-diyl, spiro[3.3]heptane-2,6-diyl, piperidine-2,5-diyl, decahydronaphthalene-2,6-diyl, 1,2,3,4-tetrahydronaphthalene-2,6-diyl, indane-2,5-diyl, thiophene-2,5-diyl, fluorene-2,7-diyl or octahydro-4,7-methanoindane-2,5-diyl, with the proviso that all of the above groups may be unsubstituted or mono- or polysubstituted with T and may have one of meanings defined for L,
T is P-Q-, H, OH, halogen, SF₅, NO₂, a carbon group or a hydrocarbon group,
i quantity of W and j quantity of Z are the same as or different from one another and are each —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ—, —CF₂CH₂—, —CH₂CF₂—, —(CF₂)ₙ—, —CH═CH—, —CF═CF—, —C≡C—, —CH═CH—COO—, —OCO—CH═CH—, —CUV or a single bond,
U and V are each independently H or a C₁-C₁₂ alkyl group,
i and k are each independently 0 or 1, with the proviso that i+k>0,
j is 0, 1, 2 or 3, and
n is 1, 2, 3 or 4,
with the proviso that when polymerizable compound (C) includes a polymerizable compound of formula [III], R and R′ in formula [I] for cyclohexane compound (A) are not n-propyl groups at the same time, and
wherein the alignment controlling layer comprises a polymer resulting from polymerization of the polymerizable compound and a photopolymerization initiator that are contained in the liquid crystal composition for forming the liquid crystal layer.

11. The liquid crystal display according to claim 10, further comprising:
an alignment film in at least one space between the alignment controlling layer and the substrate.

12. The liquid crystal display according to claim 11, wherein the alignment film comprises a polymer compound comprising polyimide, polyamide or polysiloxane.

13. The liquid crystal display according to claim 12, wherein the alignment film comprises polyimide.

14. The liquid crystal display according to claim 10, of a display mode of TN mode, IPS mode, FFS mode or VA mode.
